(19) United States
(12) Patent Application Publication
(10) Pub. No.: US 2016/0004738 A1
(43) Pub. Date: Jan. 7, 2016

(54) SYSTEMS AND METHODS OF GENERATING A NAVIGABLE, EDITABLE MEDIA MAP

(71) Applicant: MediaGraph, LLC, Berkeley, CA (US)

(72) Inventors: Alex Lee Kerfoot, Oakland, CA (US); Orion Reblitz-Richardson, Berkeley, CA (US); Randall Breen, San Rafael, CA (US); Sina Jafarzadeh, San Francisco, CA (US); A. Peter Swearengen, San Francisco, CA (US); William Ralph Wright, Oakland, CA (US)

(21) Appl. No.: 14/714,705

(22) Filed: May 18, 2015

Related U.S. Application Data
(63) Continuation of application No. 14/336,997, filed on Jul. 21, 2014.
Application No. 14/336,997 is a continuation of application No. 14/214,372, filed on Mar. 14, 2014.
(60) Provisional application No. 61/928,626, filed on Jan. 17, 2014.
(60) Provisional application No. 61/800,577, filed on Mar. 15, 2013.

(51) Int. Cl. G06F 17/30

(52) U.S. Cl. CPC G06F 17/30327; G06F 17/30345; G06F 17/3002

(57) ABSTRACT

Libraries containing numerous media items such as movies, music, and still images can be difficult to organize in a meaningful and accessible way. To more efficiently and aesthetically organize media items in a library, media maps are generated from hierarchical trees. The media maps are displayed to a user via a user display device. The user can quickly navigate through the media maps to discover connections and similarities between media items previously unknown to the user. The user can further make changes to the media map by interacting with the media map via a user interface. The media map is then re-generated to reflect the changes made by the user. The user can thus personalize the automatically generated media map to reflect his own media preferences and opinions.

### PRIORITY

This non-provisional U.S. patent application is a continuation of U.S. patent application Ser. No. 14/336,997 filed Jul. 21, 2014, which is a continuation of U.S. patent application Ser. No. 14/214,372 filed Mar. 14, 2014, which claims priority to, and the benefit of, U.S. Provisional Patent Application No. 61/800,577 filed Mar. 15, 2013 and U.S. Provisional Patent Application No. 61/928,626 filed Jan. 17, 2014, the entirety of each of which are hereby incorporated by reference herein.

### BACKGROUND

1. Field

This patent application is directed generally to libraries of content, and, more specifically, to media maps of the libraries of content.

2. Description of Related Art

With the rise of digital media, media libraries have grown to include large volumes of content, such as music, movies, and images. These large libraries can be difficult to organize in a meaningful way that allows a user to locate items of interest and identify relationships between items. As the size of media libraries continues to increase, the need for efficient and accurate curation of such media libraries becomes ever more urgent.

Prior attempts to organize media items include generating fictional maps of content. These maps are generated by artists as still pieces of art based on the knowledge of a single user. Some heavily artistic and curated examples include a static, graphic map of songs available at http://www.wearedorothy.com/shop/song-map-original-open-edition/ and a hand-rendering of a media map covering the history of music at http://www.youtube.com/watch?v=If_T1Q9u6FM. However, these maps are not updateable as more content becomes available or by viewers of the maps. These maps further fail to reveal relationships known to other users about the media items.

### SUMMARY

According to some embodiments, a method comprises: obtaining, by a computing system, a hierarchical tree of nodes wherein each node is one of a plurality of media items each having a prominence level indicative of a relative popularity of the media item; and generating, by the computing system, a hierarchical Voronoi media map of cells by: for each parent node of the hierarchical tree of nodes, if one or more of its child nodes of the parent node have a prominence level that is two prominence levels below the prominence level of the parent node, generating a pseudo child node positioned in the hierarchical tree of nodes below the parent node and above the one or more child nodes and having a prominence level that is one prominence level below the prominence level of the parent node, assigning to a cell of the hierarchical Voronoi media map of cells, a first media item of the plurality of media items having a highest prominence level, determining a number of child nodes or pseudo child nodes of each of the parent nodes of the hierarchical tree of nodes, generating one or more child filler points so that the first media item assigned to the cell has a pre-defined total number of child nodes, pseudo child nodes, and child filler points, dividing the cell to which the first media item is assigned into subdivided cells, and assigning to each of the subdivided cells, a child node of the first media item that is a second media item of the plurality of media items, a pseudo child node that is the first media item of the plurality of media items, or a child filler point.

According to some embodiments, a system comprises a communication module configured to obtaining, by a computing system, a hierarchical tree of nodes wherein each node is one of a plurality of media items each having a prominence level indicative of a relative popularity of the media item; and a map generation module configured to, by the computing system, generate a hierarchical Voronoi media map of cells, the map generation module configured to: for each parent node of the hierarchical tree of nodes, if one or more child nodes of the parent node have a prominence level that is two prominence levels below the prominence level of the parent node, generate a pseudo child node positioned in the hierarchical tree of nodes below the parent node and above the one or more child nodes and having a prominence level that is one prominence level below the prominence level of the parent node, assign to a cell of the hierarchical Voronoi media map of cells, a first media item of the plurality of media items having a highest prominence level, determine a number of child nodes or pseudo child nodes of each of the parent nodes of the hierarchical tree of nodes, generate one or more child filler points so that the first media item assigned to the cell has a pre-defined total number of child nodes, pseudo child nodes, and child filler points, divide the cell to which the first media item is assigned into subdivided cells, and assign to each of the subdivided cells, a child node of the first media item that is a second media item of the plurality of media items, a pseudo child node that is a first media item of the plurality of media items, or a child filler point.

According to some embodiments, a non-transitory computer-readable medium having instructions embodied thereon, the instructions executable by one or more processors to perform operations comprising: obtaining, by a computing system, a hierarchical tree of nodes wherein each node is one of a plurality of media items each having a prominence level indicative of a relative popularity of the media item; and generating, by the computing system, a hierarchical Voronoi media map of cells by: for each parent node of the hierarchical tree of nodes, if one or more of its child nodes of the parent node have a prominence level that is two prominence levels below the prominence level of the parent node, generating a pseudo child node positioned in the hierarchical tree of nodes below the parent node and above the one or more child nodes and having a prominence level that is one prominence level below the prominence level of the parent node, assigning to a cell of the hierarchical Voronoi media map of cells, a first media item of the plurality of media items having a highest prominence level, determining a number of child nodes or pseudo child nodes of each of the parent nodes of the hierarchical tree of nodes, generating one or more child filler points so that the first media item assigned to the cell has a pre-defined total number of child nodes, pseudo child nodes, and child filler points, dividing the cell to which the first media item is assigned into subdivided cells, and assigning to each of the subdivided cells, a child node of the first media item that is a second media item of the plurality of media items, a pseudo child node that is the first media item of the plurality of media items, or a child filler point.

### BRIEF DESCRIPTION OF THE DRAWINGS

FIG. 1 is an example of a navigable, editable media map, according to one embodiment.

FIG. 2 is an example environment in which various embodiments can be practiced.

FIG. 3 is a flowchart of an example method of generating the media map, according to an example embodiment.

FIG. 4 is an example hierarchical tree, according to an example embodiment.

FIG. 5 is a pseudo node representation of the example hierarchical tree, according to the example embodiment.

FIG. 6 is a media map, according to the example embodiment.

FIG. 7 is a further depiction of the media map, according to the example embodiment.

FIG. 8 is a flowchart of an example method of generating labels, according to an example embodiment.

FIG. 9 is an example table containing metadata tags, according to an example embodiment.

FIG. 10 is an example of a hierarchical tree having labels, according to an example embodiment.

FIG. 11 is example edit being made to the hierarchical tree having labels, according to an example embodiment.

FIG. 12 is an example of the result of the edit made to the hierarchical tree having labels, according to an example embodiment.

FIG. 13 is an example of a media map at a first level of zoom, according to an example embodiment.

FIG. 14 is the example of the media map at a second level of zoom, according to an example embodiment.

FIG. 15 is the example of the media map at a third level of zoom, according to an example embodiment.

FIG. 16 is an example of a media map, according to an example embodiment.

FIG. 17 is an example hierarchical tree from which the media map was generated, according to an example embodiment.

FIG. 18 is an example depiction of the media map as it is being edited, according to an example embodiment.

FIG. 19 is a further depiction of the media map as it is being edited, according to an example embodiment.

FIG. 20 is a depiction of the edit made to the media map, according to an example embodiment.

FIG. 21 is an example of a further media map, according to an example embodiment.

FIG. 22 depicts an example user interaction to promote a media item, according to an example embodiment.

FIG. 23 is an example of the further media map after it has been edited, according to an example embodiment.

FIG. 24 is an example of another media map, according to an example embodiment.

FIG. 25 depicts an example media map as it is being edited, according to an example embodiment.

FIG. 26 is an example of the other media map after it has been edited, according to an example embodiment.

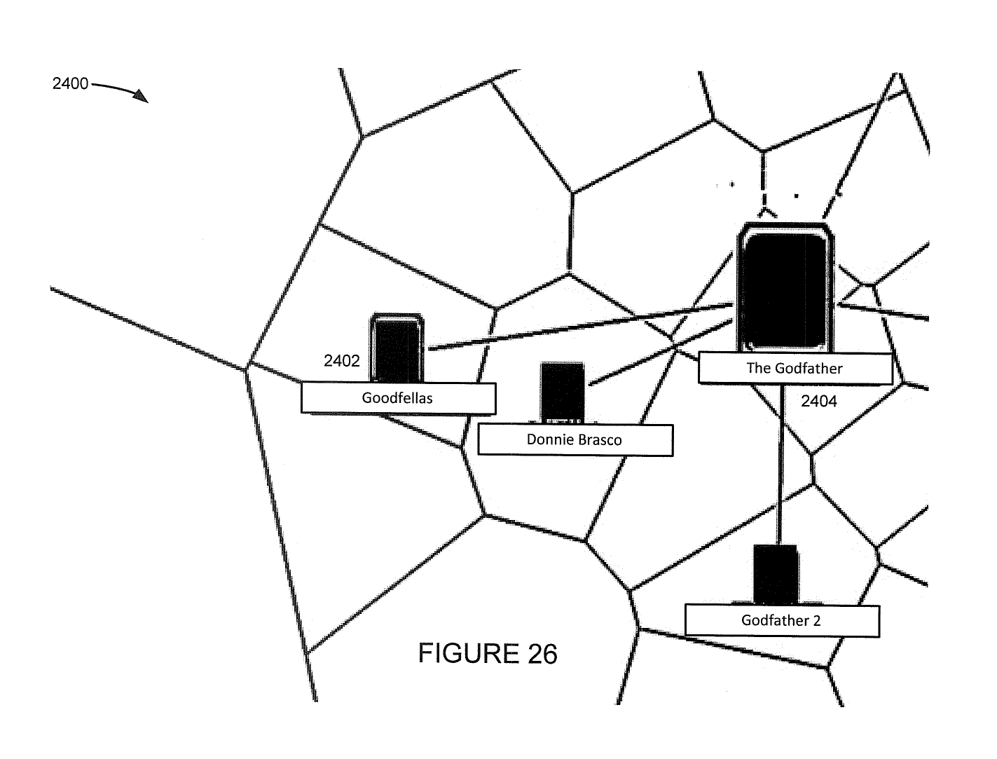

FIG. 27 is another example of the other media map after it has been edited, according to an example embodiment.

### DETAILED DESCRIPTION

A generalized system is configured to create a media map that reflects similarity and relevance between media items within a library including movies, music, images, and the like. The media map has a hierarchical Voronoi (HV) cell structure that divides a two-dimensional space into regions, or cells, of varying size and position. The media map is displayed to the user and is navigable by virtue of a physics-based layout model and editable by a user through interactions via a user interface.

The media map can be generated quickly and on the fly for a particular library. The process in which the media map is generated is agnostic to the contents of the library and to the number of media items in the media library. Further, because metadata characterizing the media items in the library and used to create the media map can originate from the user, from other users, and/or from third party metadata providers, the media map can reflect similarities and relationships between media items known to other users that were previously unknown to the user to whom the media library belongs. As media items are added to the library or as additional metadata about the media items become available, the media map can be re-generated. The regenerated media map includes the added media items and/or incorporates the additional metadata. Thus, the media map can evolve over time while incorporating new media items and new information about the media items.

The media map can be rendered and displayed by a user display device to resemble a geographical map where similar media items appear as a continent and empty space appears as oceans, mountains, and other dividing terrain features. The displayed media map can be navigated by zooming and panning using pre-defined user interactions. The pre-defined user interactions include, in some embodiments, a scroll or touch gesture or by clicking and dragging or by touching and dragging onto empty space.

The media map is generated from a hierarchical tree that characterizes each media item in two ways: by its position relative to other media items and by a prominence level that indicates the relative popularity of the media item. Example methods and systems to generate the hierarchical trees are provided in U.S. patent application Ser. No. 14/214,372, of which this patent application is a continuation. Specifically, regions or clusters comprising hierarchical Voronoi cells are generated around a media item having a higher prominence level than other media items in a sub-tree of the hierarchical tree. To maintain consistency between the hierarchical tree and the media map, pseudo nodes can be added to the tree, at the root- or top-node, as well as in the hierarchy. The hierarchical tree, modified to include pseudo nodes, is used to create the media map, with a one-to-one mapping between the nodes in the modified hierarchical tree and the cells in the media map. Starting at the top of the hierarchical tree, cells in the media map at a highest prominence level are subdivided if there are child media items at a next lower prominence level in the hierarchical tree and subdivided again if there are child media items at a still lower prominence level, and so forth. The process continues until there are no further child media items at a given prominence level for a given sub-tree in the hierarchical tree. As a result, some cells of the media map can be subdivided into only one level, while others can be subdivided into ten or more levels.

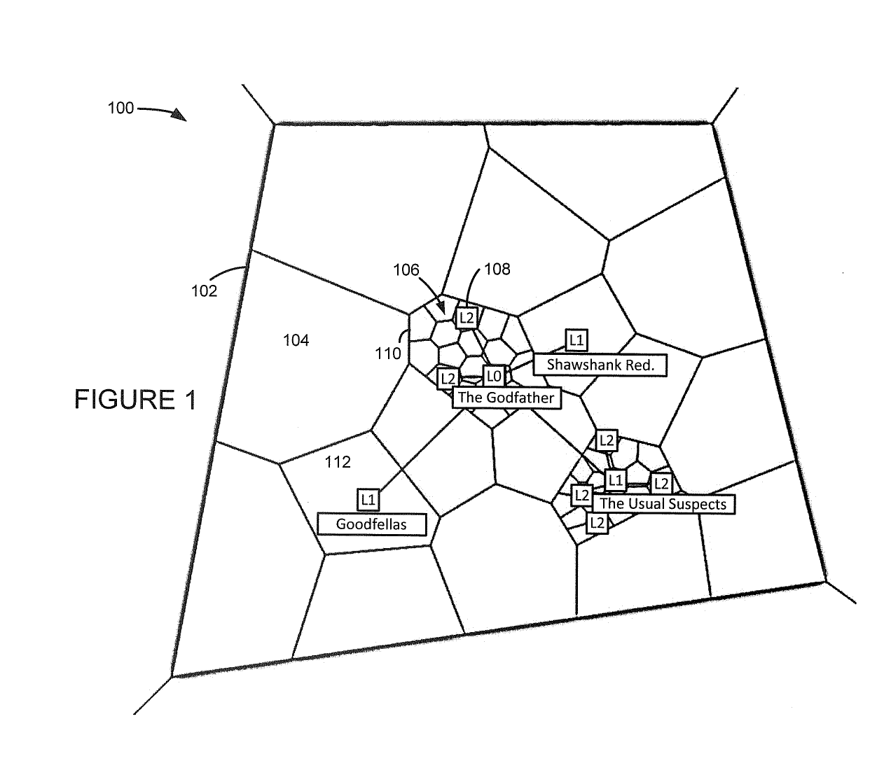

FIG. 1 is an example of a navigable, editable media map 100, according to one embodiment. The media map is generated as a Voronoi diagram. Voronoi diagrams are used by mathematicians to divide a two-dimensional region into a number of cells, where each cell identifies a region about a point. Given a set of points distributed in space, Voronoi diagrams can be quickly generated and/or re-generated by computers. By manipulating the positions of the set of points, the Voronoi diagram can be changed. Further, mathematical techniques, such as Lloyd's relaxation, can be used to refine Voronoi diagrams.

The media map 100 includes a number of Voronoi cells that each are assigned to, and represent, a media item, a pseudo node, or a filler node in the hierarchical tree. The media map 100 has similar media items placed in proximity to other similar media items and according to a hierarchy where a media item can be the parent or the child of another media item. Child media items are positioned within a subdivision of the Voronoi cell that represents the parent media item.

The size of the cell depends on a prominence level of the media item, the pseudo node, or the filler node. The prominence level of a media item is a quantitative indication of its popularity relative to other, similar media items. Media items having a higher prominence level are assigned to larger Voronoi cells than media items having a lower prominence level.

In the media map 100, the prominence levels of the media items, and by association, the Voronoi cells representing the media item, are indicated within a square having the identifiers: “L0”, “L1”, and “L2”. In the embodiment shown, the prominence level “L0” is associated with the media item having the highest prominence level, the prominence level “L1” is associated with the media items having the next lower prominence level, and the prominence level “L2” is associated with the media items having a further lower prominence level. Similarly, the Voronoi cells within the media map 100 are of a size corresponding to the prominence level of the media item. For example, the movie “The Godfather” has a prominence level L0 and is assigned to a Voronoi cell 102. Subdivided cells can each respectively represent a child media item of the L0 media item in the hierarchical tree having a prominence level of L1. As such, media items that are siblings in the hierarchical tree are positioned in proximity to one another in the media map 100. The Voronoi cell 102 is subdivided into Voronoi cells such as Voronoi cell 104 being a filler cell, Voronoi cell 110 assigned to a level L1 pseudo node, and Voronoi cell 112 assigned to an L1 child of “The Godfather”. For example, and as depicted in FIG. 1, Voronoi cell 110 can be subdivided further into Voronoi cells such as Voronoi cells 106 and 108 if the assigned media item has at least one child media item. The further subdivided cell 106 in the Voronoi cell 110 can, like Voronoi cell 108, respectively represent a child media item of a media item that has an L2 prominence level in the hierarchical tree. The Voronoi cell 106 can be a filler cell.

The media map 100 can be displayed, navigated and edited via one or more user interactions with a user interface, as described elsewhere herein.

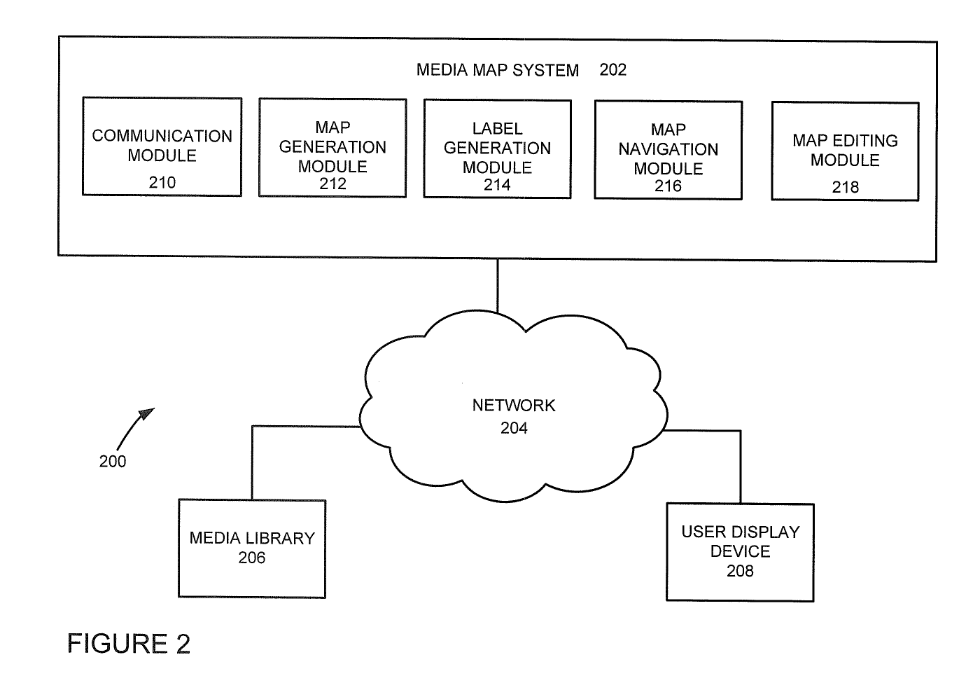

Referring now to FIG. 2, an example environment 200 in which various embodiments can be practiced is shown. In the example environment 200, a media map system 202 is configured to obtain a hierarchical tree via a network 204 (e.g., the Internet). The media map system 202, upon obtaining the media items (or identifiers thereof) and/or the hierarchical tree from a media library 206, can generate a media map. The media map system 202 can transmit the generated media map across the network 204 to one or more user display devices 208 for display, navigation, and editing. The user display device 208 can receive an instruction from the user to edit or change the media map and transmit the instruction over the network 204 to the media map system 202. The media map system 202 can interpret the received instruction, cause a tree manager (e.g., tree manager 202 described in U.S. patent application Ser. No. 14/336,997, of which this patent application is a continuation) to modify a hierarchical tree, and re-generate the media map based on the modified hierarchical tree.

The media map system 202 comprises a communication module 210, a map generation module 212, a label generation module 214, a map navigation module 216, and a map editing module 218. The media map system 202 can be implemented in a variety of ways known to those skilled in the art including, but not limited to, as a computing device having a processor with access to a memory capable of storing executable instructions for performing the functions of the described modules. The computing device can include one or more input and output components, including components for communicating with other computing devices via a network (e.g., the network 204) or other form of communication. The media map system 202 comprises one or more modules embodied in computing logic or executable code such as software.

The communication module 210 obtains a hierarchical tree and prominence levels of media items from the media library 206 or from a similarity system (e.g., the similarity system described in U.S. patent application Ser. No. 14/214,372, of which this patent application is a continuation) via the network 204. In some instances, the similarity system, the tree manager, the client display device 208, and/or the media library 206 can be co-located with the media map system 202. The media map system 202 is configured to receive instructions from a user using the user display device 208 (e.g., via the network 204) to display the media map, to navigate the media map, and/or to change a position of a media item in a media map or to change a prominence level of a media item in the media map. The media map system 202 then executes the instruction and makes changes to the position or prominence level of media items in the media map as necessitated by the instruction and as described herein. After the media map is edited, the communication module 210 can provide a display of the edited media map to the user display device 208.

The map generation module 212 is configured to generate a media map from one or more obtained hierarchical trees and the prominence levels corresponding to the media items within the hierarchical trees. In some embodiments, the map generation module 212 is configured to, as an intermediate step described herein, generate pseudo nodes as necessitated by the prominence levels of the media items within the obtained hierarchical tree. The map generation module 212 can modify or regenerate at least a portion of the media map after a change is made to the media map, the hierarchical tree, or a prominence level of a media item.

The label generation module 214 is configured to generate labels that identify regions of the media map (labels not included in FIG. 1). As is described herein, the labels are generated from metadata tags assigned to the respective media items in a region of the media map or in a sub-tree of the hierarchical tree. In some instances, the metadata tags can be obtained from the similarity system.

The map navigation module 216 is configured to allow a user to navigate through the media map via a user interface. Example navigation operations include, but are not limited to, zooming and panning. The map navigation module 216 can perform a navigation operation based on an instruction received from a user using the user display device 208, or from another module within the media map system 202.

The map editing module 218 is configured to receive an instruction from a user using the user display device 208 to edit the media map. The map editing module 218 can, in turn, instruct a tree manager (e.g., the tree manager 202 described in U.S. patent application Ser. No. 14/336,997, of which this patent application is a continuation) to edit the hierarchical tree and/or the prominence levels of some of the media items. The map editing module 218 can then instruct the map generation module 212 to regenerate at least a portion of the media map based on the edited hierarchical tree.

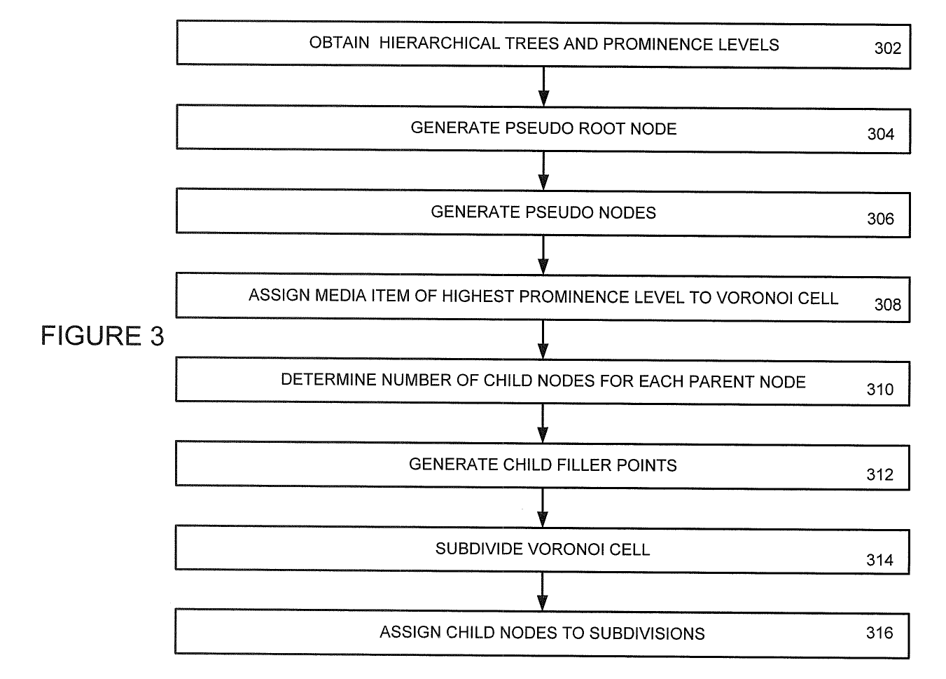

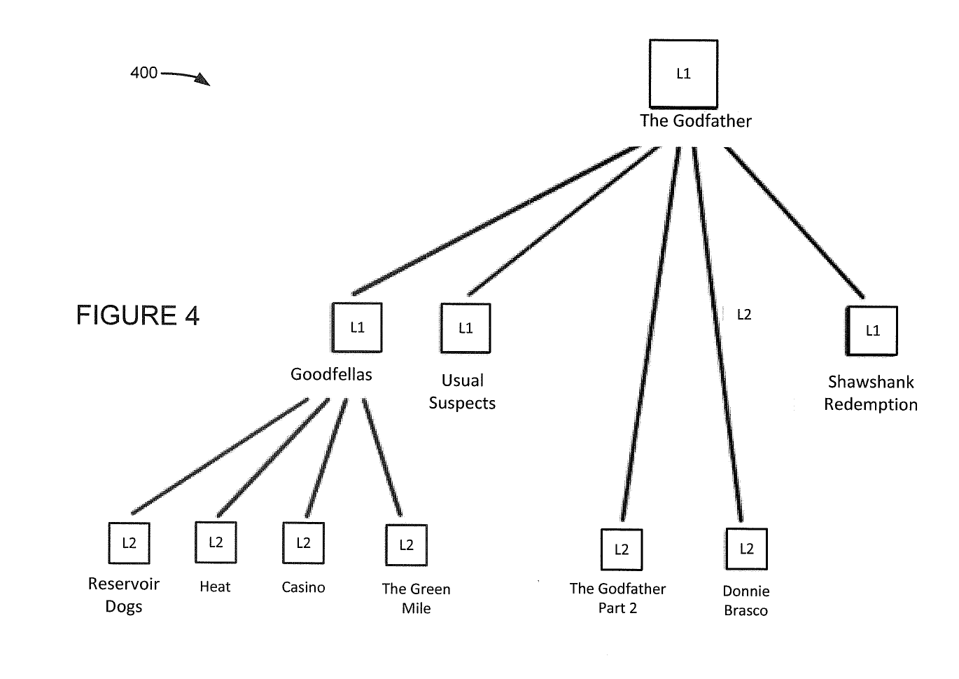

Referring now to FIG. 3, a flowchart of an example method 300 of generating the media map according to one embodiment is shown. The method 300 can be performed by the map generation module 212 and is described in connection with the examples depicted in FIGS. 4-7.

In an operation 302, one or more hierarchical trees of media items and prominence levels of the media are obtained. Each node in the hierarchical tree is a media item such that one media item can be the parent, or representative of, one or more child media items.

Referring now to FIG. 4, an example hierarchical tree is depicted. The hierarchical tree 400 is an organization of media items into a structure that reflects similarity and relative prominence between the media items. Systems and methods for generating the hierarchical tree and prominence levels are described in U.S. patent application Ser. No. 14/214,372, of which this application is a continuation application.

The hierarchical tree 400 has leaf and non-leaf nodes that are media items. Assigning media items as non-leaf nodes and, therefore, representatives for a tree or a sub-tree means the media item (for example, “The Godfather”) stands for and represents an entire tree or sub-tree. A media library 206 typically includes multiple hierarchical trees, with each hierarchical tree having a root node or representative (the media item in the hierarchical tree having the highest prominence level) and each sub-tree having its own representative. The root media item can have children of different prominence levels. The trees can be laid out such that each tree is radial around the root node, creating clusters and sub-clusters of representative content.

In the hierarchical trees, every node has a distinct prominence level. The prominence levels start at the most prominent (and, in an embodiment, largest when displayed on the screen) labeled “L0,” and progress to lower levels of prominence such as L1, L2, L3, L4, L5, etc. (it is to be noted that, as is thus clear, a lower prominence number represents a higher prominence level). The prominence level of a given media item can be represented in the form PROM_LEVEL(media), which outputs an Lx value. The prominence level of the media item is not directly linked to its position within the hierarchical tree structure, but is initially a calculated prominence value indicating the relative popularity of the media item and can be adjusted by the user. The prominence level can be used to determine how the media item is depicted within a user interface (e.g., media items having a higher prominence level can be depicted by icons that are larger than icons that represent media items having a lower prominence level). When the hierarchical trees are obtained, the child nodes within the hierarchical tree are invariably at a prominence level that is lower than the prominence level of its parent.

Referring again to FIG. 4, hierarchical tree 400 is shown having media items (in this example, movies) with prominence levels. Each media item that is a node in the hierarchical tree has a prominence level shown internal to the square adjacent to the label identifying the media item. In FIG. 4, “The Godfather” is the L0 root node of a hierarchical tree that has “Goodfellas” as an L1 representative node for the children: “Reservoir Dogs”, “Heat”, “Casino”, and “The Green Mile”. “The Usual Suspects” and “Shawshank Redemption” have no children (and only represent themselves because they have no children) and are denoted as L1, which means they are at the same prominence level as “Goodfellas”. “The Godfather Part 2” and “Donnie Brasco” are denoted as L2, but are parented to (and are thus represented by) only “The Godfather”. This means that “The Godfather” is both their L0 and L1 representative. “The Godfather Part 2” and “Donnie Brasco” (both denoted as L2) have the same prominence level as “Reservoir Dogs”, “Heat”, etc. (other L2 items) but they are positioned below or around “The Godfather” when the hierarchical tree is displayed.

Returning to the method 300 of FIG. 3, and as can be performed by the map generation module 212 of FIG. 2, the hierarchical Voronoi media map is generated from the hierarchical tree. To generate the media map, the following operations are performed to generate a pseudo node representation of the obtained hierarchical tree and to generate the Voronoi cells in the media map.

In an optional operation 304 that is performed when more than one hierarchical tree is obtained in the operation 302, a pseudo-root (PR) node is generated. The root nodes (e.g., the nodes having the highest prominence level) of each obtained hierarchical tree is parented to the generated PR node. The result of the operation 304 is that all of the obtained hierarchical trees are combined into a single hierarchical tree while maintaining the distinct structures and properties of the obtained hierarchical trees. The operation 304 can be skipped when only one hierarchical tree is obtained in the operation 302.

In an operation 306, pseudo nodes are generated and added to the hierarchical tree. A pseudo node is added if one or more child nodes of a parent node have a prominence level that is two or more prominence levels below the prominence level of the parent node. The pseudo node is positioned below the parent node and above the one or more child nodes and has a prominence level that is at least one prominence level below the prominence level of the parent node and at least one prominence level above the one or more child nodes. In some embodiments, only one pseudo child node is generated for each parent node at each prominence level. If a child node has a prominence level that is more than two prominence levels below that of its parent, more than one pseudo node can be generated and positioned between the parent node and the child node so that each prominence level is represented (or “filled”) in the pseudo node representation.

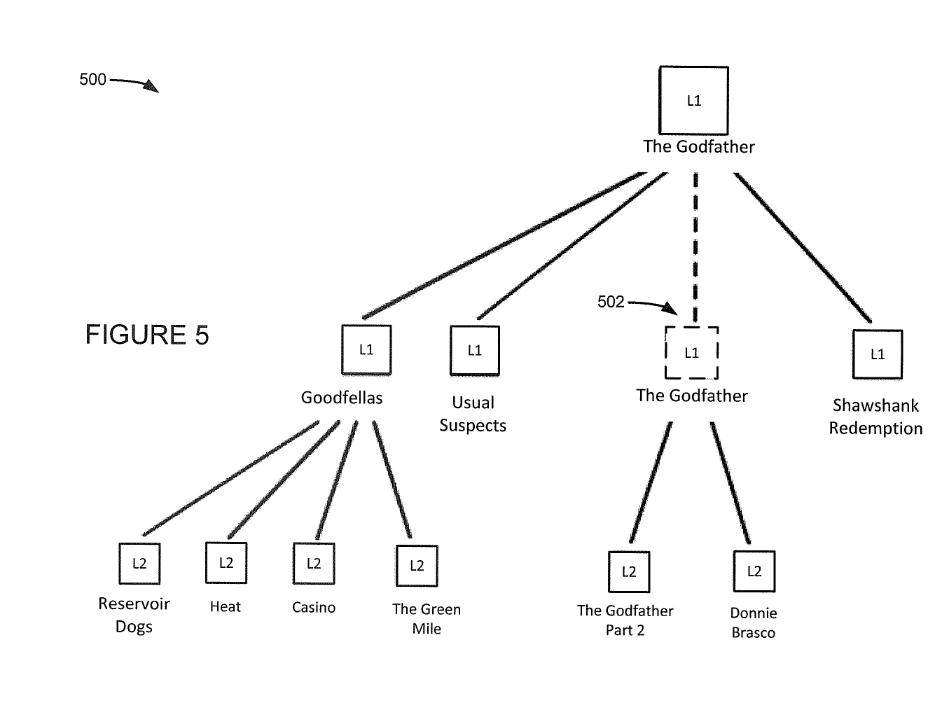

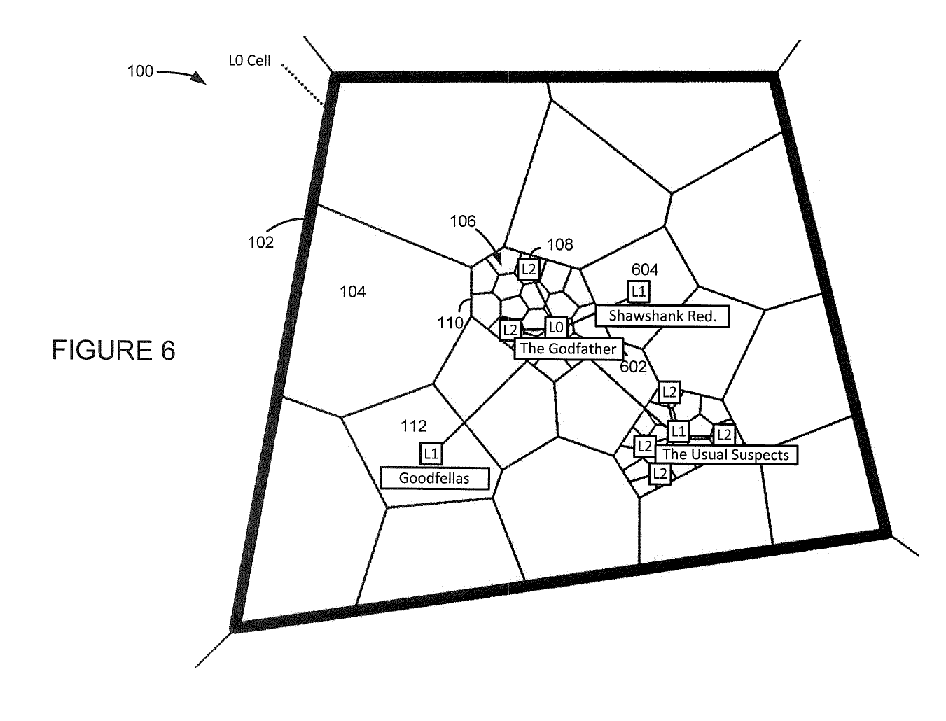

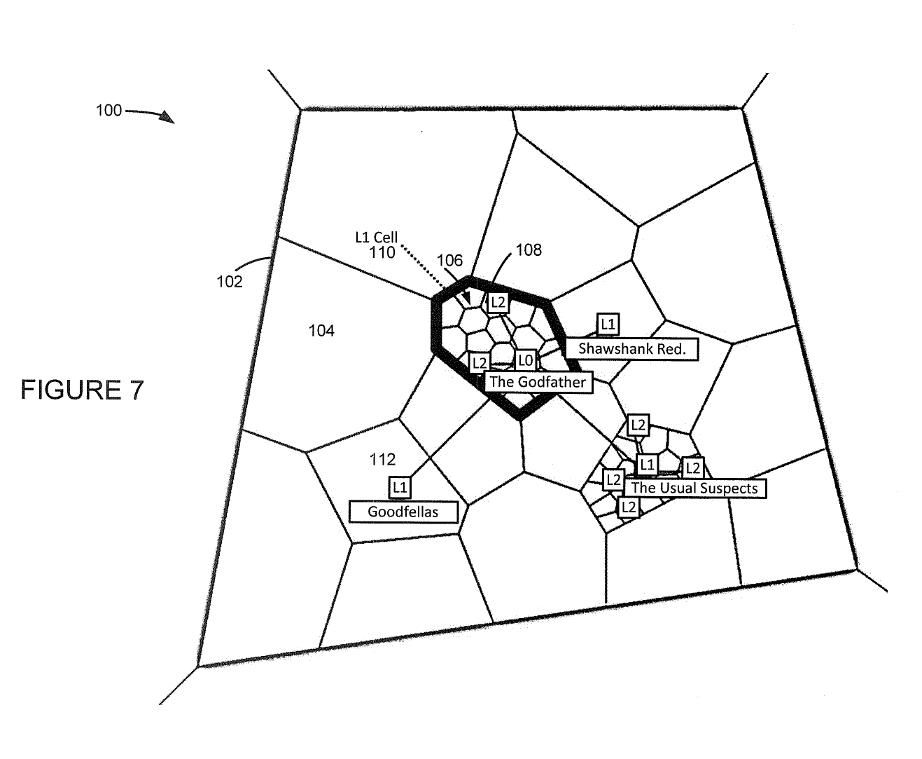

To illustrate, and referring now to FIG. 5, when the root node with prominence level L0 (“The Godfather”) has children at multiple levels of prominence (L1 and L2, as shown), a pseudo node child (“The Godfather”) 502 is generated and positioned below the root node and above the child nodes that have the lower prominence level. As depicted, the pseudo node 502 has a prominence level of L1 and is the L1 parent of both L2 child media items: “The Godfather Part 2” and “Donnie Brasco”. As depicted, “The Godfather” having children at both the L1 and L2 prominence levels, occupies multiple cells on the map, each at a different level of prominence. In FIG. 6, “The Godfather's” L0 Cell 102 contains “Goodfellas” and “The Shawshank Redemption”, but in FIG. 7, “The Godfather's” L1 Cell 110 only contains its child media items having a prominence level of L2 (e.g., “The Godfather Part 2” and “Donnie Brasco”).

Returning to FIG. 3, in an operation 308, the media item having a highest prominence level is assigned to a Voronoi cell. If one hierarchical tree was obtained in the operation 302, the root node of the hierarchical tree is assigned to a Voronoi cell. If more than one hierarchical tree was obtained in the operation 302, the PR node generated in the operation 304 is assigned to a Voronoi cell.

In an operation 310, for each parent node in the pseudo node representation that has at least one child node or pseudo child node, the number of child nodes or pseudo child nodes of the node is determined. The child nodes and the pseudo child nodes are each at the next lower prominence level than the parent node. In some embodiments, each parent node is limited to having one pseudo child node; the pseudo child node is counted along with the child nodes.

In an operation 312, for each parent node, one or more child filler points are generated. To provide a similar level of detail at each prominence level in the media map, each cell is subdivided into an equal number of subdivisions, referred to as the subdivision target. To account for the difference between the number of child nodes (including a pseudo child node) and the subdivision target, a number of child filler points equal to the difference are generated so that the media item assigned to the cell that is a parent node has a pre-defined total number of child nodes, pseudo child nodes, and child filler points. In the example embodiment of FIGS. 6 and 7, the subdivision target is pre-defined to be eighteen. The location of filler points can initially be assigned randomly and distributed according to Lloyd relaxation. Lloyd relaxation is a technique familiar to those skilled in the art.

In an operation 314, the Voronoi cell is subdivided into further Voronoi cells for each child node, pseudo child node, and child filler point. As is known to those skilled in the art, Voronoi cell boundaries can be calculated for a number of points in several different ways. In some embodiments, and using knowledge known to those skilled in the art, the cell boundaries can be calculated to create edges that are equal distance between the point and adjacent points. In the media maps described herein, each point can represent a media item.

In an operation 316, a media item, a pseudo child node (that represents the parent media item), or a child filler point is assigned to each subdivision. The cells assigned to the child filler points are referred to herein as “filler cells” or “empty cells” and are represented as empty space on the map. This empty space is where the media map system 202 can insert terrain detail (for example, trees, mountains, rivers, oceans, etc.) and as a place for new content (for example, recommendations, new content added by the user from outside music libraries 206, etc.). The operations 310 through 316 are repeated for each parent node in the hierarchical tree until every media item is represented in the media map.

Referring again to FIGS. 6 and 7 depictions of the media map 100 (FIG. 1) generated from pseudo node tree representation of FIG. 5 are shown. The root node media item 602 (e.g., “The Godfather”) has children at multiple prominence levels (L1 and L2) (e.g., “Goodfellas” assigned to Voronoi cell 112 and the L2 child media item assigned to Voronoi cell 108), and a child pseudo node 502 assigned to Voronoi cell 110. On the media map 100, the root node media item is assigned to the L0 cell 102 (highlighted in FIG. 6) and, as highlighted in FIG. 7, to a subdivision (e.g., Voronoi cell 110) of the L0 cell 102, labelled “L1 cell,” assigned to the child pseudo node 502. In FIG. 6, “The Godfather”'s “L0 Cell” 102 contains its L1 children, “Goodfellas” (e.g. Voronoi cell 112) and “The Shawshank Redemption” (e.g., Voronoi cell 604). In FIG. 7, “The Godfather”'s “L1 Cell” 110 contains its L2 children, “The Godfather Part 2” and “Donnie Brasco” (due to space limitations in the figure, shown as boxes containing the text “L2”) (e.g., Voronoi cell 108).

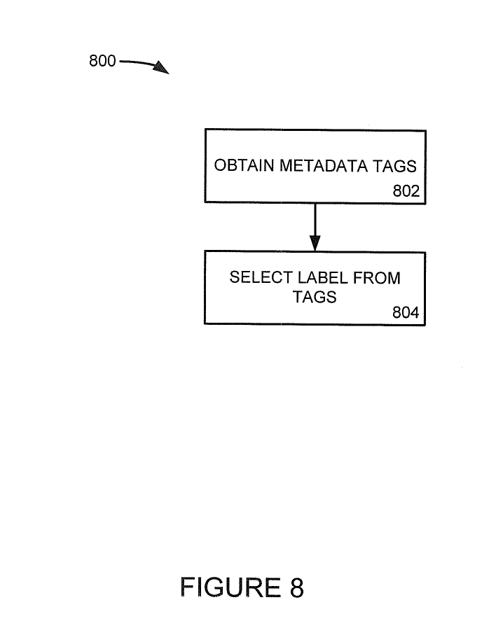

FIG. 8 is a flowchart of an example method 800 of generating labels for a region of the media map (e.g., media map 100), according to an example embodiment. The method 800 can be performed by the label generation module 214. In one embodiment, within each region (i.e., Voronoi cell or cluster) of the media map, the most common tags on media items are used to automatically generate area labels. These area labels are displayed on the media map as the description for a particular region. The labels are generated by calculating the union of all tags for media items within the Voronoi cell and picking the most common and highly-weighted tag within that whole cell. The weights of tags coming from media items having a higher prominence level are multiplied by a factor, so that the metadata tags assigned to the more prominent media items have more impact on the generated area label and so lower-prominence content does not overpower the tags from a smaller set of higher-prominence content. For tags that repeat across content within the cell, the weights are accumulated.

In an operation 802, tags assigned to each media item in the region of the media map (e.g., a subtree of the hierarchical tree) are obtained from, e.g., the media library 206. The metadata tags are obtained by iterating through the tree structure corresponding to the cell from the bottom-up, to collect tags from all media items within the sub-tree. At each level, the tags from the sub-tree below a representative M (i.e., parent node) are combined with the tags from the representative itself.

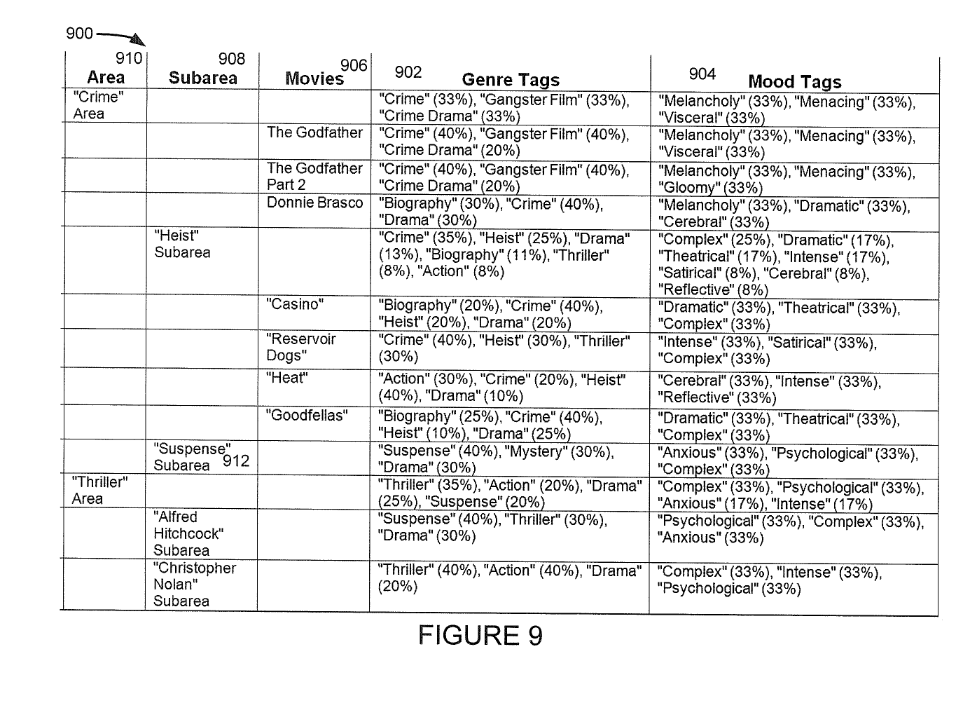

FIG. 9 is an example table 900 containing metadata tags (e.g., genre tags 902 and mood tags 904), according to an example embodiment. Each metadata tag has a value (e.g., “Crime”, “Gangster Film”, “Crime Drama”) and an associated tag weight that is expressed as a percentage. From these obtained metadata tags, the tag weights are multiplied by a label factor dictated by the prominence level of the media item as

LABEL_FACTOR=1/(1.2̂PROM_LEVEL(M)).

Second, the tag weights are multiplied by a similarity factor (not shown). The similarity factors are predefined values such as ARTIST_FACTOR, ALBUM_FACTOR, GENRE_FACTOR, MOOD_FACTOR, and TEMPO_FACTOR (additional detail is provided in U.S. patent application Ser. No. 14/214,372, of which this application is a continuation). The combined tags are sorted and stored in association with the representative media item M.

Referring again to FIG. 8, in an operation 804, the sub-tree is iterated top-down to select the area labels for Voronoi cells. At each level, the highest-weighted tag is selected as the area label for the Voronoi cell. The combined tags on the representative media item M are sorted by weight, with the highest-weighted first where the first combined tag of the representative media item M is selected as the area label and that tag is then excluded from child cell tag collections, so it does not repeat as the label for lower-level Voronoi cells.

As an example, in FIG. 9, the table 900 contains the values and weights of tags for the categories “Genre” and “Mood” (genre tags 902 and mood tags 904) provided by metadata providers and user tagging for the movies “The Godfather”, “The Godfather Part 2”, “Donnie Brasco”, “Casino”, “Reservoir Dogs”, “Heat”, and “Goodfellas” (contained in rows identified by column “Movies” 906). The set of collected and averaged tags for the sub-areas corresponding to sub-trees in the hierarchical tree: “Heist Movies”, “Suspense”, “Alfred Hitchcock”, and “Christopher Nolan” are also listed in the rows corresponding to the column “Subarea” 908. The set of collected and averaged tags for the areas corresponding to the hierarchical trees: “Crime” and “Thriller” are also listed in the rows corresponding to the column “Area” 910.

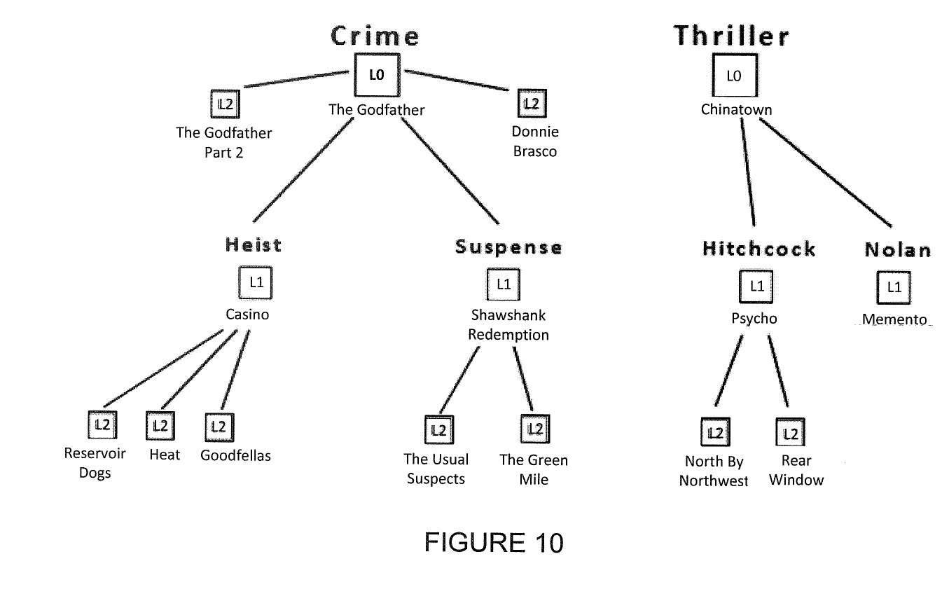

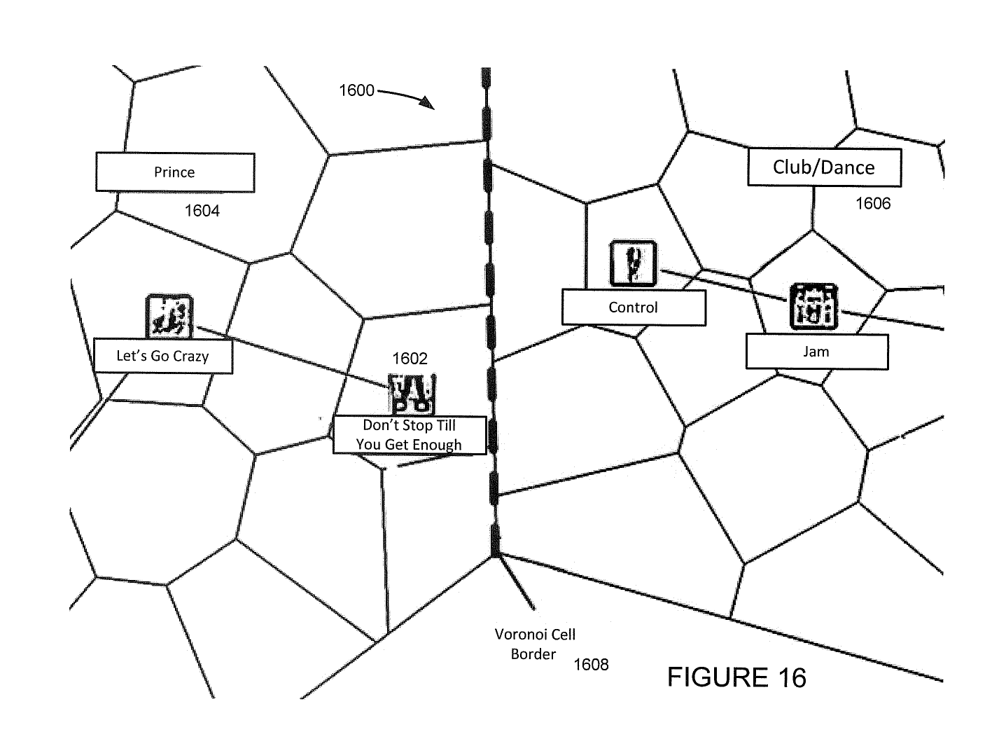

In FIG. 10, depicting an example hierarchical tree having labels, the area labels for the two clusters are initially calculated to be “Crime” and “Thriller” because they are the most highly-weighted tags within the Voronoi cells (e.g., the portions of the media map corresponding to sub-trees in the hierarchical tree) as detailed in table 900. Upon generating a media map from these hierarchical trees, the selected label of each Voronoi cell can be displayed at the corresponding location on the media map (e.g., as shown in FIG. 16).

In an example embodiment, as the user changes clusters by click-and-drag of media items, promotes and demotes them manually by clicking a button in the interface, and adds new tags to media through the interface, the labels are immediately regenerated and persisted by the label generation module 214 using the same process as the original calculation. This means that as a user moves content into a Voronoi cell (or up and down the hierarchy within a cell) the user sees common factors (tags) immediately appear on the screen as area labels (and terrain details based on these area labels) are regenerated.

As the user interacts with media items on the screen (e.g., promotion, demotion, and tag changes performed by dragging and dropping the media items), the label generation module 214 updates the hierarchical tree and then recalculates area labels based on the most highly-weighted tags in the new structure.

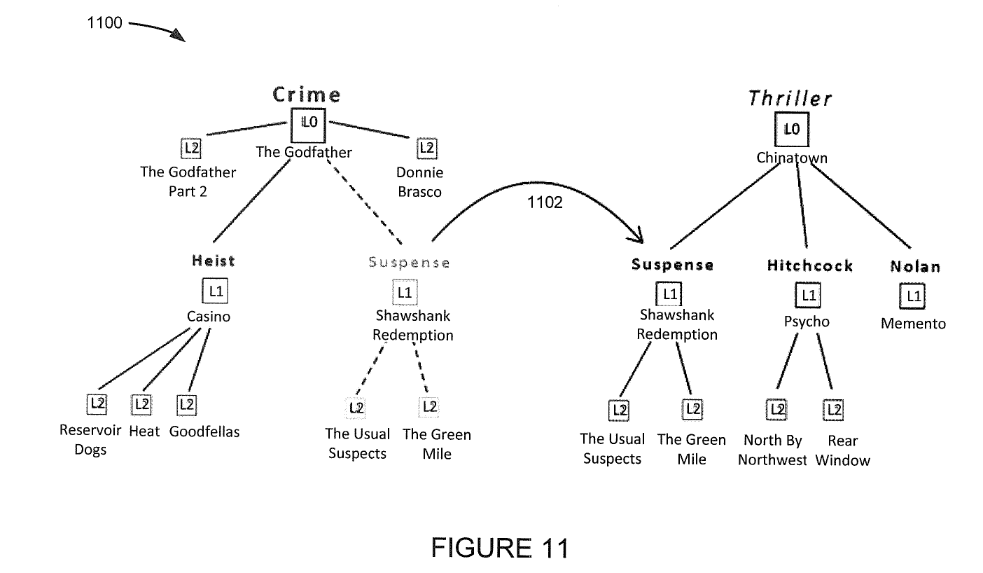

FIG. 11 is an example edit that can be made to the hierarchical tree having labels. As depicted by arrow 1102, the user moves the sub-cluster (e.g., the portion of the media map corresponding to a sub-tree in the hierarchical tree) with the most prominent media item “Shawshank Redemption” (and area label “Suspense”) and parents it to “Chinatown” (with the area label “Thriller”). The mechanics of how this edit can be performed is more fully described in U.S. patent application Ser. No. 14/336,997, of which this application is a continuation.

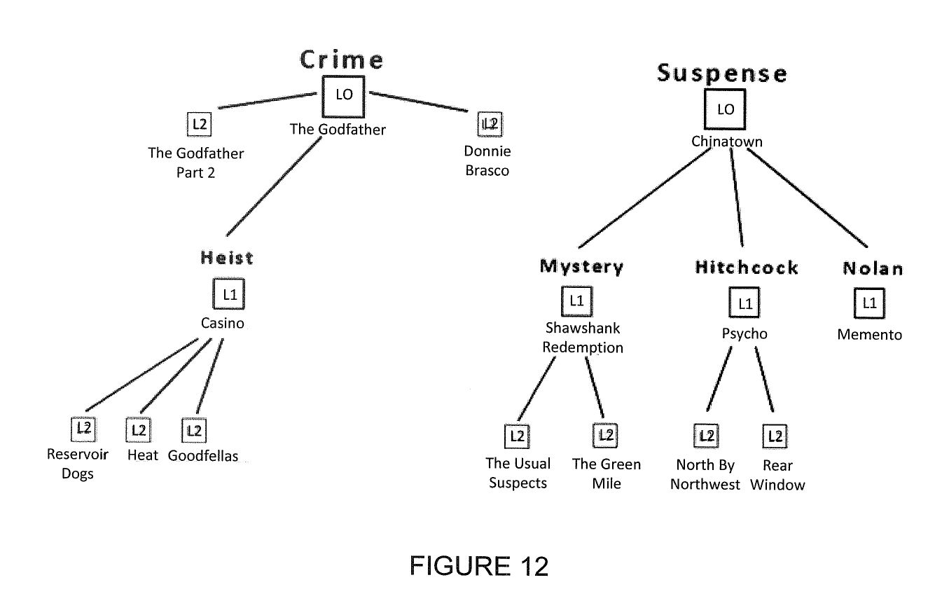

In response to the edit depicted in FIG. 11, the area labels are recalculated using the method 800. The result of the edit made to the hierarchical tree having labels is shown in FIG. 12.

In the recalculation, the operation 802 of obtaining the tags is performed by iterating through the tree structure corresponding to the cluster from the bottom up to collect tags from all media items within the tree. At each level, the tags from the sub-tree below a representative are combined with the tags from the representative itself. As shown in table 900, the sub-tree under the “Suspense” subarea 912 has the genre tags “Suspense” (40%), “Mystery” (30%), “Drama” (30%) and the mood tags “Anxious” (33%), “Psychological” (33%), “Complex” (33%). These are combined with the predefined values GENRE_FACTOR=2 and MOOD_FACTOR=1 to be “Suspense” (26%), “Mystery” (20%), “Drama” (20%), “Anxious” (11%), “Psychological” (11%), “Complex” (11%). The combined tags for sub-trees under “Shawshank Redemption”, “Psycho”, and “Memento” are calculated with the metadata tags from the table 900 and with the previous steps. After the edit is performed, these combined tags are added to the tags from “Chinatown” (not shown) to calculate for the tree under “Chinatown”. When calculating with the metadata tags from the table 900, the resulting tags are “Suspense” (24%), “Mystery” (20%), etc. Comparing FIG. 11 to FIG. 12, the label for “Chinatown” is thus changed from “Thriller” to “Suspense.”

This change is effected by the operation 804 that is performed after the edit is made. In the re-performance of the operation 804, the tree is iterated through the tree top-down to select the area labels for clusters and sub-clusters. For the cluster under “Chinatown”, the area label “Suspense” is calculated. The label “Suspense” is then excluded from all other area labels, so the sub-cluster under “Shawshank Redemption” receives an area label of “Mystery” (being the next most heavily weighted tag for the former “Suspense” sub-area as calculated in the operation 802) instead. As stated, the entire tree of labels is re-calculated, from the top-down, each time an area label is calculated. In other embodiments, the re-calculation can be limited to the sub-trees affected by the edit (e.g., operation 802). The re-calculated labels are then populated on the media map for display by, for example, the label generation module 214.

In addition to having labels, the displayed media map is navigable by the user via a user interface on the user display device 208. Zooming, facilitated by the map navigation module 216, allows a user, via the user interface, to navigate the media map (e.g., media map 100) by zooming into a region using a combination of geometric and linear zooming techniques. In one embodiment, a geometric scale relative to zoom is used, which preserves a visual density at high and low levels of zoom even though the media items have fixed positions in the media map. This provides a condensed representation of a large media collection at a high level of zoom plus greater detail at lower levels.

To provide similar levels of visual detail at each zoom level while still distinguishing between media items at the various prominence levels, both a linear and a geometric scale are used. The geometric scale is defined by a ratio, “GEO_RATIO,” that provides exponential growth in size of the media items up to a target height, “BASE_HEIGHT”. The linear scale is defined by a ratio, “LINEAR_SCALE,” that slowly increases the size of the media item after it reaches the target height, “BASE_HEIGHT”. For a given level of zoom Z (starting at 0, increasing as the user zooms in), the size factor X of a nonlinear element with prominence P (also starting at 0, increasing for lower levels of prominence) is defined as

IF (Z−P)<0:

X=BASE_HEIGHT*GEO_RATIÔ(Z−P)

ELSE:

X=BASE_HEIGHT+LINEAR_SCALE*(Z−P)

This means that an element geometrically zooms to the target size (X=1) and then slowly, linearly, continues to grow at a more subtle rate. This makes it so displayed media items having the highest prominence level (e.g., prominence level L0) will look geometrically bigger than displayed media items having a lower prominence level (e.g., prominence level L1) at Z=0, but only slightly bigger at Z=1. In some implementations, the values for the above constants are GEO_RATIO=3, and LINEAR_SCALE=10, but these values are tunable. The tuning of GEO_RATIO is done so as to achieve a target visual density and, by increasing GEO_RATIO, causes media items having even lower prominence levels to appear “hidden” from the user. LINEAR_SCALE is tuned so as to differentiate between media items having different prominence levels at a given level of zoom (for example to differentiate between media items having the prominence level L0 from those having the prominence level L1, at zoom level Z=1).

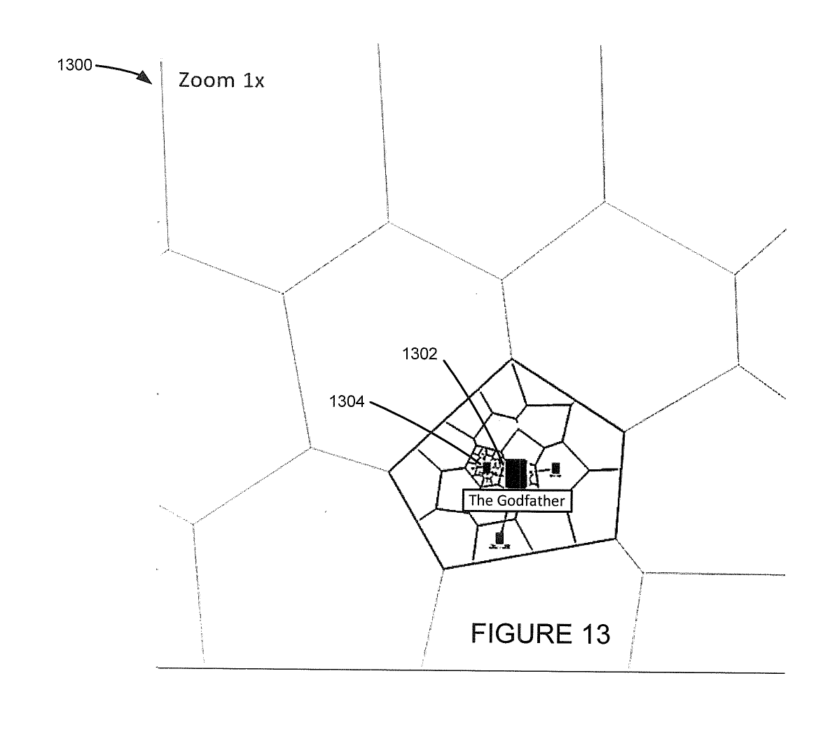

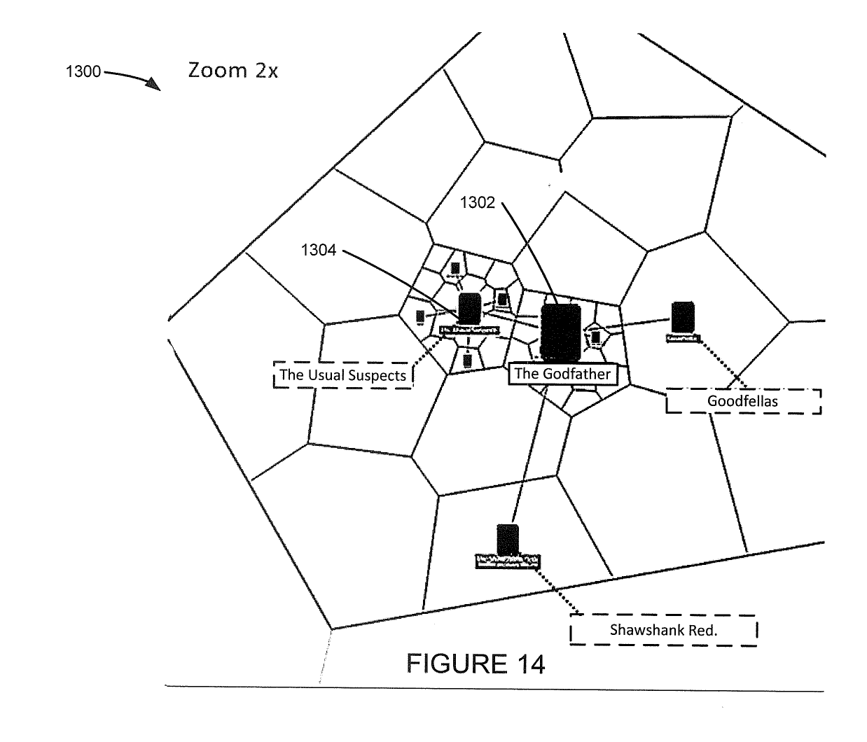

As depicted in FIG. 13, an example of a media map 1300 at a first level of zoom, the user is initially presented with a display of the hierarchical voronoi cell structure at Zoom 1× (Z=0). As depicted in FIG. 14, an example of the media map 1300 at a second level of zoom, after the user instructs the map navigation module 216 to zoom into Zoom 2× (Z=1) by, for example, scrolling their mouse or using a touch gesture on the user display device 208, the user sees a non-linear change in scale of the media items. At 1×, in FIG. 13, “The Usual Suspects” 1304 is ¼ the size of “The Godfather” 1302, but at 2×, in FIG. 14, “The Usual Suspects” 1304 is ½ the size of “The Godfather” 1302. This is because “The Usual Suspects” (an L1) was scaled up more quickly (geometrically), while “The Godfather” (an L0) was scaled up more slowly (linearly) at this level of zoom.

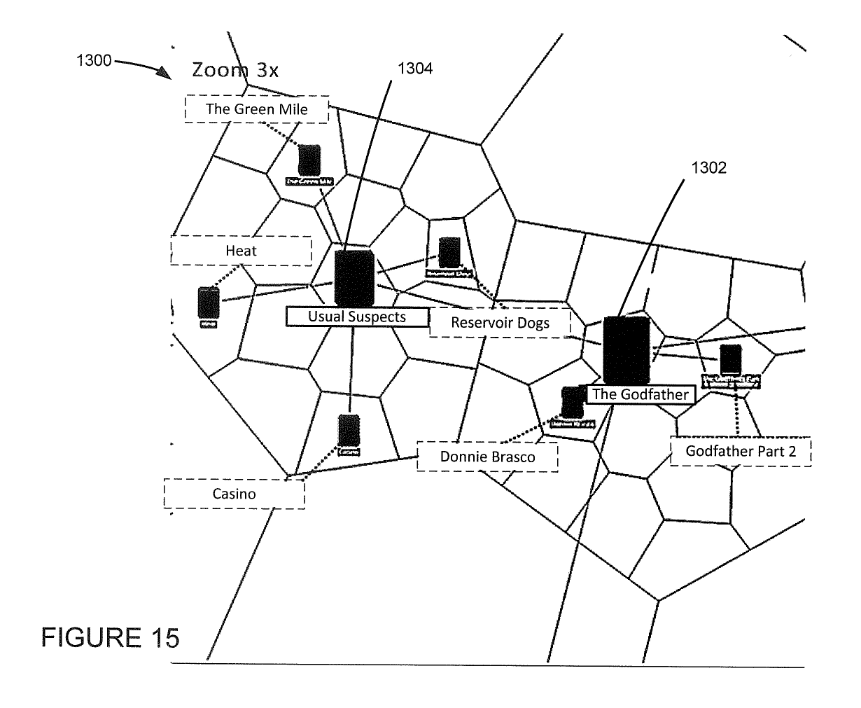

As depicted in FIG. 15, an example of the media map 1300 at a third level of zoom, the non-linear change of scale appears furthermore as the user instructs the map navigation module 216 to zoom into Zoom 3× (Z=2). At 3×, in FIG. 15, “The Usual Suspects” is almost the same size as “The Godfather”. At this point, due to no longer meeting the condition in the “IF” statement that the difference between the zoom level and the prominence is less than 0, the media items are both scaled linearly, but lower prominence media items (“Reservoir Dogs”, “Heat”, “Casino”, etc.) are scaled up geometrically and are starting to take up more space on the screen.

The map editing module 218 of FIG. 2 is configured to edit the generated media map according to instruction received from a user via a user interface at the user display device 208. The Voronoi cells of the media map can be manipulated to allow the user, via the user interface, to rearrange the media items corresponding to the manipulated cells into different clusters or regions of the media map. A user can initiate a movement of a media item having a lower prominence level onto or over another cell corresponding to a media item having a higher prominence level. This movement can be interpreted by the map editing module 218 as an instruction to re-parent the media item (and any child media items) to the representative media item corresponding to the other cell. The representative media item is presented as the largest element in the region and is highlighted as element or elements are dragged over the cell by the user.

As depicted in FIG. 16, which depicts an example of a media map 1600 before it is edited by a user, the media item “Don't Stop Til You get Enough” 1602 is assigned to the cluster 1604 labelled “Prince”. The cluster 1604, “Prince,” is adjacent to another cluster 1606 labelled “Club/Dance” and separated by Voronoi cell border 1608.

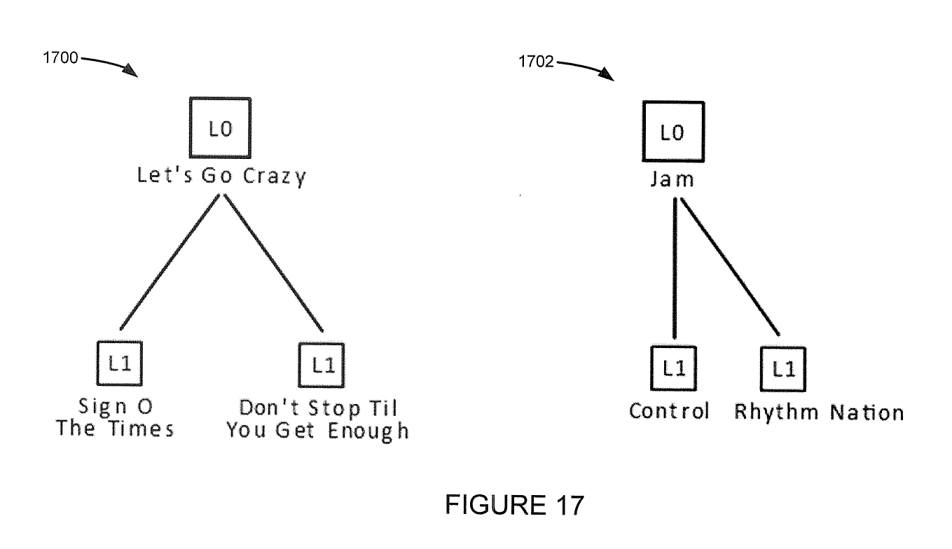

Referring now to FIG. 17, hierarchical trees 1700 and 1702 from which the media map 1600 was generated are depicted. In the hierarchical tree 1700, the media item “Don't Stop Til You Get Enough” is an L1 child media item of L0 media item “Let's Go Crazy.” “Jam” is the L0 representative of a second hierarchical tree 1702. For simplicity, FIG. 16 is cropped and does not depict every child media item included in hierarchical trees 1700 and 1702. The media map 1600, in its full and complete form, includes the child media items that are shown in FIG. 17.

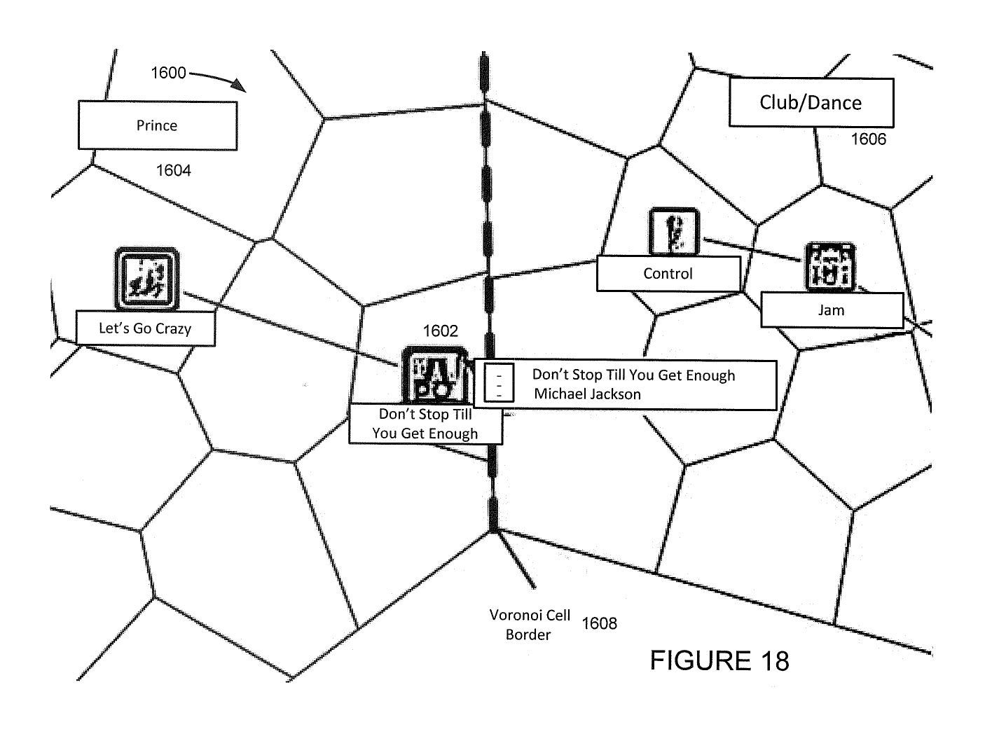

If the user wants to parent “Don't Stop til You Get Enough” from the cluster 1604 “Prince” to the cluster 1606 “Club/Dance”, as shown in FIGS. 16 and 17, he can move, via a user interface, the media item from the cluster 1604 “Prince” over the Voronoi cell border 1608 to the cluster 1606 “Club/Dance”. The movement is depicted in FIG. 18. Specifically, the map editing module 218 shows the media item 1602 being moved “Don't Stop Til You Get Enough” highlighted and positioned closer to the Voronoi cell border 1608.

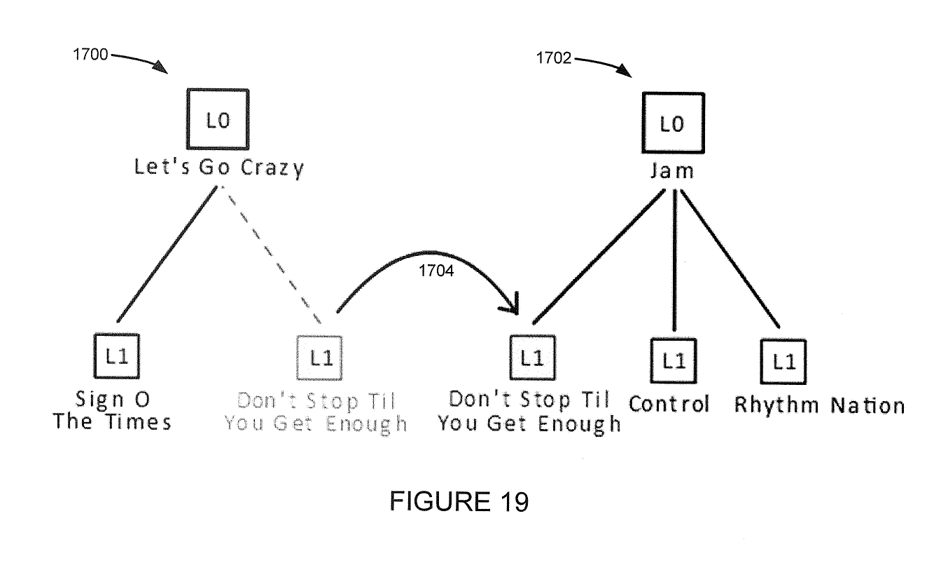

To effect the change in the media map 1600, the edit is made in the hierarchical trees 1700 and 1702. In FIG. 19, the effects of the edit initiated in the media map 1600 is shown by the arrow 1704 such that the parent-child relationship between “Lets Go Crazy” and “Don't Stop Til You Get Enough” is severed, and a new parent-child relationship is established between “Jam” and “Don't Stop Til You get Enough”. In some embodiments, the hierarchical trees 1700 and 1702 are not displayed to the user when editing the media map 1600.

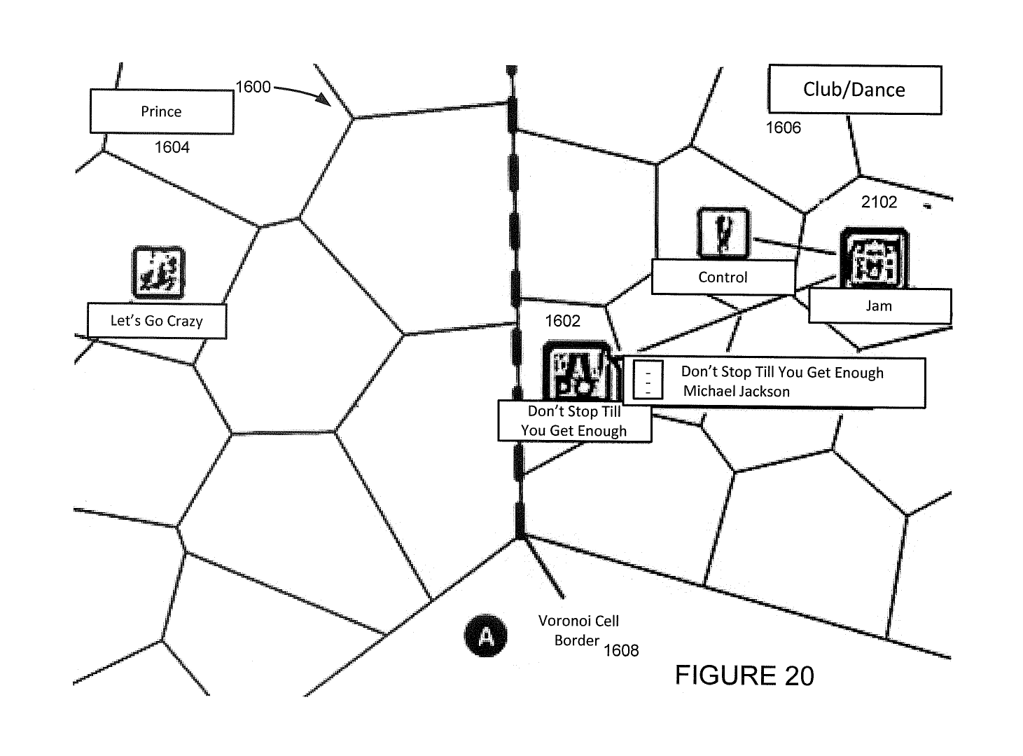

In FIG. 20, depicting the updated media map, the media item 1602 “Don't Stop Til You Get Enough” has been dragged across the Voronoi cell border 1608 by the user using the user device 208. The map editing module 218 automatically regenerated the media map to reflect the changes made in the hierarchical tree that re-parent the media item 1602 to the media item 2102 “Jam”, which is the representative media item for the “Club/Dance” cluster 1606 as shown in FIG. 20.

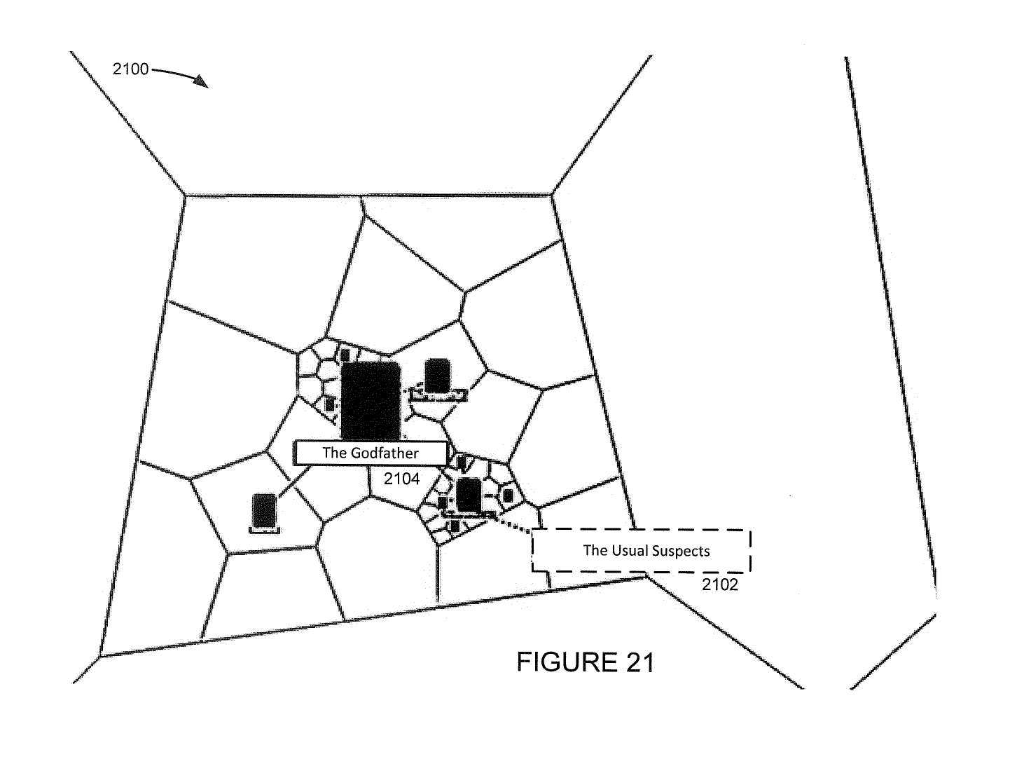

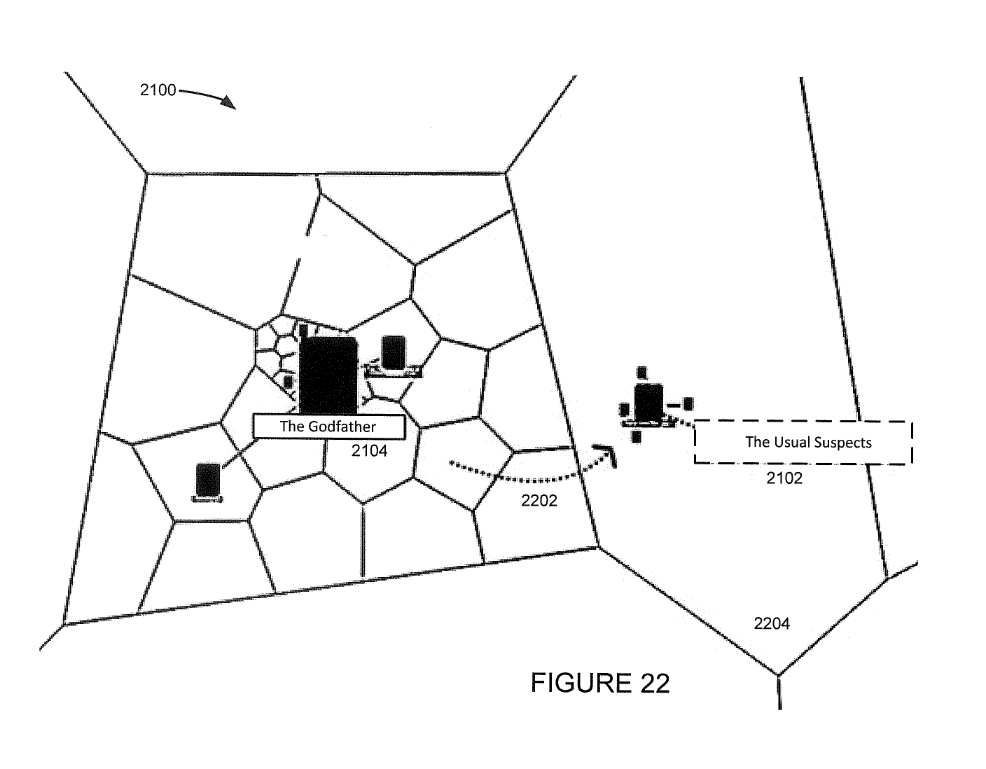

Another way that a media map can be edited is depicted in FIGS. 21-23. In FIG. 21, a media map 2100 contains a media item 2102 “The Usual Suspects” that is parented to media item 2104 “The Godfather” (the media item 2102 is positioned within a subdivision of the Voronoi cell corresponding to the media item 2104). In FIG. 22, as depicted by arrow 2202, the media item 2102 “The Usual Suspects” is moved or dragged by the user to an empty space (e.g., a filler cell 2204). The movement is interpreted by the map editing module 218 of FIG. 2 as an instruction to automatically promote the media item 2102 to a higher prominence level that corresponds to the filler cell 2204. The filler cell 2204 is re-assigned to the moved media item 2102 and is no longer an empty cell.

In some embodiments, allowing a user to drag a media item to an empty cell in the media map 2100, can be used to create new clusters at the highest available prominence level or to promote a sub-cluster within a contained hierarchical tree. When the user drags-and-drops a media item into an empty cell, the child media items of the moved media item can also be moved to the newly-assigned cell. For a tree or sub-tree of a media item dropped onto an empty cell, the moved media item is a root media item and parent to one or more child media items.

The Voronoi cell that had been assigned to the root media item is changed to an empty, or filler, cell. The Voronoi cell to which the media item was moved has an assigned prominence level by virtue of its position in the media map. The prominence level of the moved media item is set to the prominence level of the Voronoi cell to which it was moved.

To illustrate, the media item 2102 “The Usual Suspects” is moved to the filler cell 2204 in FIG. 22. The filler cell 2204 is at the same prominence level as the media item 2104 “The Godfather”. By virtue of its new position in the filler cell 2204, the media item 2102 “The Usual Suspects” is promoted to a higher prominence level, which is the same as the prominence level of the media item 2104, “The Godfather”.

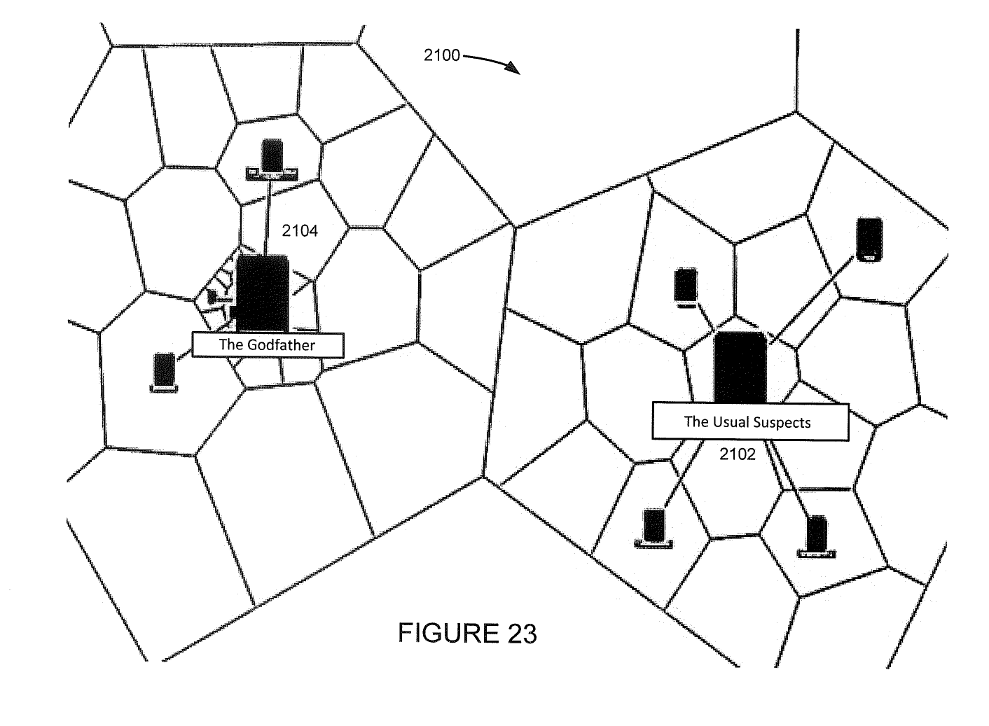

When a parent media item is moved, the prominence levels of the child media items are also updated. In some embodiments, each child media item is promoted or demoted the same number of prominence levels that the parent media item was promoted or demoted. Referring now to FIG. 23, which illustrates the result of the change depicted in FIG. 22, the moved media item 2102 “The Usual Suspects” is promoted one prominence level and, likewise, its child media items are each promoted by one prominence level.

Rather than promoting a media item to a higher prominence level, a user can edit the media map to demote a media item by dragging (or otherwise interacting with the displayed media map) a media item (and/or sub-cluster of which the media item is the representative) close enough to (e.g., within a specified radius of), or within the boundaries of, a destination Voronoi cell corresponding to another media item at the same prominence level. This interaction can be interpreted as an instruction to automatically demote the representative media item and re-position the media item and/or the sub-cluster within the destination Voronoi cell. Normally the force layout of the media map pushes the media items within a given parent cell apart to evenly distribute them. However, when the user drags a media item, the other media items directly within the parent cell are forced away more slowly so the user has the opportunity to drag media items close together. When the user drags a media item element, the map editing module 218 reduces the Lloyd relaxation force towards the centroid for all media siblings (other media items within the same parent cell) for that media item. The Lloyd relaxation force on filler points and all other media items is unchanged. This system of selective forces on user drag lets the map editing module 218 provide an even distribution and layout of content, while also letting the user drag items together.

When the user drags-and-drops a media item close enough to a new parent media item having the same prominence level as the dragged media item, the dragged media item is demoted and any child media items are demoted. The prominence level of the dragged media item is lowered to one prominence level lower than that of its new parent media item. The prominence levels of the child media items are also updated. In some embodiments, each child media item is demoted the same number of prominence levels that the dragged media item was demoted.

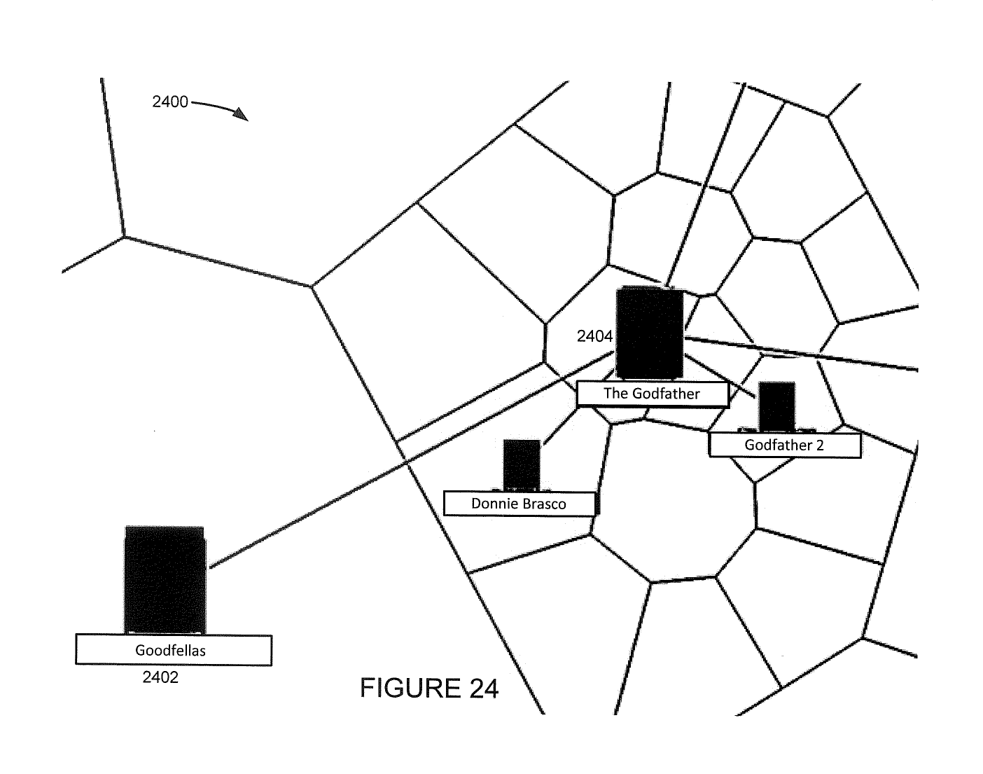

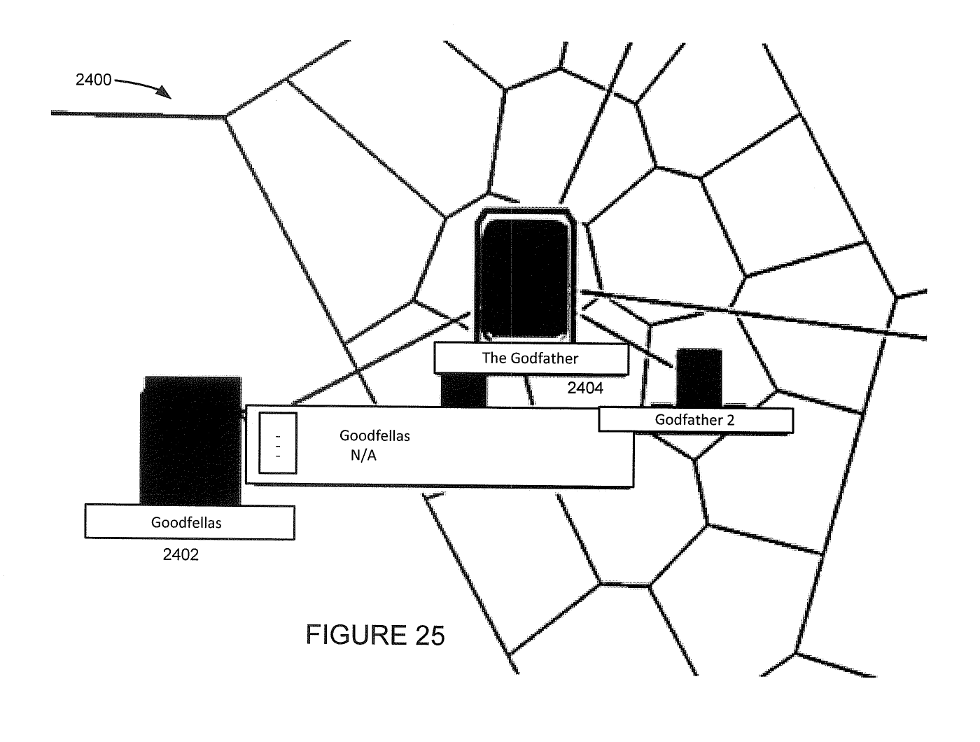

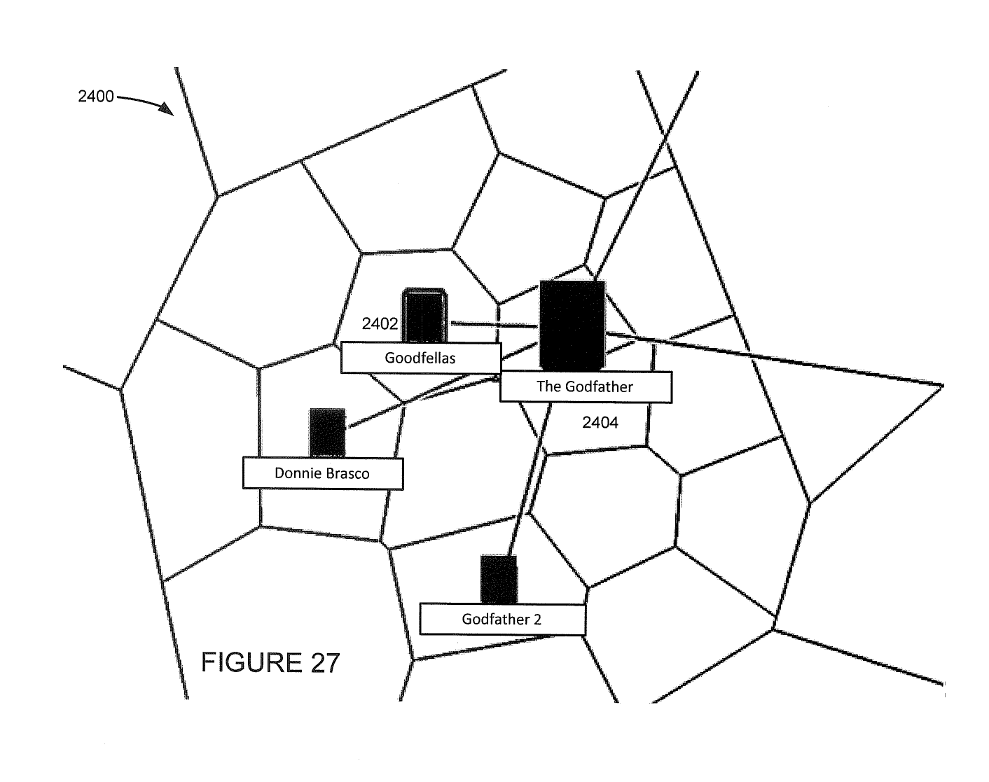

Referring now to FIG. 24, and to illustrate how a media item can be demoted, a media map 2400 is depicted. A media item 2402 “Goodfellas” is assigned to a Voronoi cell having the same prominence level as a media item 2404 “The Godfather”. As depicted in the media map 2400 of FIG. 25, the user moves the media item 2402, “Goodfellas”, towards the cluster represented by the media item 2404 “The Godfather” (it is noted, however, that the position of the media item 2402 in FIG. 25 is not yet close enough to cause the media item 2402 to be reparented and demoted). As depicted in the media map 2400 of FIG. 27, when the user moves the media item 2402 “Goodfellas” close enough to the media item 2404 “The Godfather”, it becomes a child of the media item 2404 “The Godfather”. Because the prominence level of the media item 2402 “Goodfellas” (e.g., because it was assigned to a Voronoi cell having a prominence level of L1) is equal to or greater than the prominence level of its new parent (the media item 2404 “The Godfather” having a prominence level L1 by virtue of its position in a Voronoi cell having a prominence level of L1), it is demoted to one prominence level lower than the prominence level of its new parent, which is prominence level L2. As depicted in FIG. 27, the media item 2402 “Goodfellas” is now a part of the cluster represented by the media item 2404 “The Godfather”.

As described herein, there is a unique relationship between a media item and the voronoi cell(s) to which it is assigned in a media map. Depending on whether it has a pseudo node as described above, a media item can have multiple cells associated with it, each at a different level of prominence and containing children at the next level of prominence down. Interaction with and selection of these cells (or regions) through click (or gesture) automatically selects all media items within the cell.

In addition to navigation and editing, cells within the parent cell of the edited cell are shifted to accommodate changes to the position or prominence level of the moved cell. Any user changes to the position or prominence level of media items changes the tree structure, the cell structure, and triggers force layout. Forces are localized to where the edit occurred and, in particular, at the cell being edited, any sibling cells, and sub-cells below them. For example, if a user moves a media item having a prominence level of L0, the map editing module 218 performs the force layout on the whole media map. If a user moves a media item having an L1 prominence level, the map editing module 218 performs the force layout on the L0 cell containing the moved L1 cell. This provides for a reasonably stable map during user editing operations, but also the opportunity to edit and rearrange the whole map as needed.

The disclosed method and apparatus has been explained above with reference to several embodiments. Other embodiments will be apparent to those skilled in the art in light of this disclosure. Certain aspects of the described method and apparatus may readily be implemented using configurations other than those described in the embodiments above, or in conjunction with elements other than those described above. For example, different algorithms and/or logic circuits, perhaps more complex than those described herein, may be used.

Further, it should also be appreciated that the described method and apparatus can be implemented in numerous ways, including as a process, an apparatus, or a system. The methods described herein may be implemented by program instructions for instructing a processor to perform such methods, and such instructions recorded on a non-transitory computer readable storage medium such as a hard disk drive, floppy disk, optical disc such as a compact disc (CD) or digital versatile disc (DVD), flash memory, etc., or communicated over a computer network wherein the program instructions are sent over optical or electronic communication links. It should be noted that the order of the steps of the methods described herein may be altered and still be within the scope of the disclosure.

It is to be understood that the examples given are for illustrative purposes only and may be extended to other implementations and embodiments with different conventions and techniques. While a number of embodiments are described, there is no intent to limit the disclosure to the embodiment(s) disclosed herein. On the contrary, the intent is to cover all alternatives, modifications, and equivalents apparent to those familiar with the art.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method comprising:
obtaining, by a computing system, a hierarchical tree of nodes wherein each node is one of a plurality of media items each having a prominence level indicative of a relative popularity of the media item; and
generating, by the computing system, a hierarchical Voronoi media map of cells by:
for each parent node of the hierarchical tree of nodes, if one or more child nodes of the parent node have a prominence level that is two prominence levels below the prominence level of the parent node, generating a pseudo child node positioned in the hierarchical tree of nodes below the parent node and above the one or more child nodes and having a prominence level that is one prominence level below the prominence level of the parent node,
assigning to a cell of the hierarchical Voronoi media map of cells, a first media item of the plurality of media items having a highest prominence level,
determining a number of child nodes or pseudo child nodes of each of the parent nodes of the hierarchical tree of nodes,
generating one or more child filler points so that the first media item assigned to the cell has a pre-defined total number of child nodes, pseudo child nodes, and child filler points,
dividing the cell to which the first media item is assigned into subdivided cells, and
assigning to each of the subdivided cells, a child node of the first media item that is a second media item of the plurality of media items, a pseudo child node that is the first media item of the plurality of media items, or a child filler point.

2. The method of claim 1, further comprising generating a pseudo root node that is the parent node of a root node of the hierarchical tree and of at least one addition root node of another hierarchical tree.

3. The method of claim 1, wherein a second media item of the plurality of media items is a parent node of a third media item of the plurality of media items and wherein the second media item is assigned to a first subdivided cell of the subdivided cells and the third media item is positioned in a subdivision of the first subdivided cell and further comprising:
displaying the hierarchical Voronoi media map to a user via a user interface;
receiving an instruction from the user via the user interface to change the position of the third media item from the subdivision of the first subdivided cell to a subdivision of a second subdivided cell, a fourth media item being the representative media item of, and contained within, the second subdivided cell;
changing, by the computing system, the hierarchical tree so that the fourth media item is the parent node of the third media item; and
re-generating, by the computing system, the hierarchical Voronoi media map resulting in the third media item being removed from the subdivision of the first subdivided cell and positioned within the subdivision of the second subdivided cell.

4. The method of claim 3, wherein the user instruction is a drag-and-drop action within the user interface.

5. The method of claim 3, wherein the user instruction includes a further instruction to promote the third media item to a higher prominence level, and further comprising:
detecting that the further instruction causes the third media item to be promoted based on the subdivision of the second subdivided cell containing the fourth media item has a prominence level that is higher than that of the second media item;
promoting the third media item to the higher prominence level; and
changing the prominence level of the third media item in the hierarchical tree, and
wherein the regenerated hierarchical Voronoi media map depicts the third item in the subdivision of the second subdivided cell, the subdivision of the second subdivided cell being larger than the subdivision of the first subdivided cell.

6. The method of claim 5, further comprising:
if, as a result of the promotion of the third media item, each of the one or more child nodes of the fourth media item assigned to the second subdivided cell have a prominence level that is one prominence level below the prominence level of the fourth media item, removing the pseudo child node in the second subdivided cell.

7. The method of claim 3, wherein the user instruction includes a further instruction to demote the third media item to a lower prominence level, and further comprising:
detecting that the further instruction causes the third media item to be demoted based on the second subdivided cell containing the fourth media item having a prominence level that is lower than that of the second media item;
demoting the third media item to the lower prominence level; and
changing the prominence level of the third media item in the hierarchical tree, and
wherein the regenerated hierarchical Voronoi media map depicts the third item in a subdivision of the second subdivided cell, the subdivision in the second subdivided cell being smaller than the subdivision in the first subdivided cell.

8. The method of claim 1, wherein generating the hierarchical Voronoi media map further comprises generating area labels from metadata tags associated with a plurality of media items in a sub-tree of the hierarchical tree.

9. The method of claim 1, further comprising, in response to a further user instruction, zooming within a display of the generated hierarchical Voronoi media map using a geometric zoom and a linear zoom.

10. The method of claim 9, wherein the geometrical zoom is performed if a difference between a zoom level and a prominence level of a zoomed media item is less than zero.

11. The method of claim 9, wherein the linear zoom is performed if a difference between a zoom level and a prominence level of a zoomed media item is equal to or greater than zero

12. The method of claim 1, further comprising:
receiving a further instruction from the user to change a prominence level of the second media item;
changing the prominence level of the second media item to the changed prominence level;
changing the hierarchical tree based on the changed prominence level of the second media item;
regenerating the hierarchical Voronoi media map based on the changed hierarchical tree.

13. The method of claim 1, wherein generating the hierarchical Voronoi media map of cells further comprises:
determining a number of child nodes or pseudo child nodes of the second media item assigned to a subdivided cell of the subdivided cells,
generating one or more child filler points so that the second media item assigned to the subdivided cell has the pre-defined total number of child nodes, pseudo child nodes, and child filler points,
dividing the subdivided cell to which the second media item is assigned into further subdivided cells, and
assigning to each of the further subdivided cells, a child node that is a third media item of the plurality of media items, a pseudo child node that is the second media item of the plurality of media items, or another child filler point.

14. A system comprising:
a communication module configured to obtaining, by a computing system, a hierarchical tree of nodes wherein each node is one of a plurality of media items each having a prominence level indicative of a relative popularity of the media item; and
a map generation module configured to, by the computing system, generate a hierarchical Voronoi media map of cells, the map generation module configured to:
for each parent node of the hierarchical tree of nodes, if one or more child nodes of the parent node have a prominence level that is two prominence levels below the prominence level of the parent node, generate a pseudo child node positioned in the hierarchical tree of nodes below the parent node and above the one or more child nodes and having a prominence level that is one prominence level below the prominence level of the parent node,
assign to a cell of the hierarchical Voronoi media map of cells, a first media item of the plurality of media items having a highest prominence level,
determine a number of child nodes or pseudo child nodes of each of the parent nodes of the hierarchical tree of nodes,
generate one or more child filler points so that the first media item assigned to the cell has a pre-defined total number of child nodes, pseudo child nodes, and child filler points,
divide the cell to which the first media item is assigned into subdivided cells, and
assign to each of the subdivided cells, a child node of the first media item that is a second media item of the plurality of media items, a pseudo child node that is the first media item of the plurality of media items, or a child filler point.

15. A non-transitory computer-readable medium having instructions embodied thereon, the instructions executable by one or more processors to perform operations comprising:
obtaining, by a computing system, a hierarchical tree of nodes wherein each node is one of a plurality of media items each having a prominence level indicative of a relative popularity of the media item; and
generating, by the computing system, a hierarchical Voronoi media map of cells by:
for each parent node of the hierarchical tree of nodes, if one or more of its child nodes of the parent node have a prominence level that is two prominence levels below the prominence level of the parent node, generating a pseudo child node positioned in the hierarchical tree of nodes below the parent node and above the one or more child nodes and having a prominence level that is one prominence level below the prominence level of the parent node,
assigning to a cell of the hierarchical Voronoi media map of cells, a first media item of the plurality of media items having a highest prominence level,
determining a number of child nodes or pseudo child nodes of each of the parent nodes of the hierarchical tree of nodes,
generating one or more child filler points so that the first media item assigned to the cell has a pre-defined total number of child nodes, pseudo child nodes, and child filler points,
dividing the cell to which the first media item is assigned into subdivided cells, and
assigning to each of the subdivided cells, a child node of the first media item that is a second media item of the plurality of media items, a pseudo child node that is the first media item of the plurality of media items, or a child filler point.
